(19) United States
(12) Patent Application Publication
(10) Pub. No.: US 2007/0193109 A1
(43) Pub. Date: Aug. 23, 2007

(54) Cockroach trap with improved capturing rate and remote monitoring system using the same

(75) Inventor: Chan Hyuk Chyun, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Cesco Co., Ltd. Cesco B/D, Gangdong-gu (KR)

(21) Appl. No.: 10/590,763

(22) PCT Filed: Feb. 28, 2005
(86) PCT No.: PCT/KR05/00563

§ 371 Date: Aug. 24, 2006

(30) Foreign Application Priority Data
Feb. 28, 2004 (KR) 10-2004-13764

(51) Int. Cl. A01M 1/14; A01M 1/10

(52) U.S. Cl. 43/114; 43/121; 43/107

(57) ABSTRACT

There is provided a trap for improving the capture rate. A cockroach trap comprises a plate, a first birdlime adhered to at least a portion of the plate, a slant having an inclined plane and a vertical section, the slant being disposed on the plate and adjacent to at least a part of the first birdlime and a second birdlime adhered onto the vertical section.

### TECHNICAL FIELD

The present invention generally relates to a cockroach trap and a remote monitoring system, and more particularly to a cockroach trap having birdlime and a sensor for capturing cockroaches and a remote monitoring system using the same.

### BACKGROUND ART

Cockroaches are prevalent inside many homes and produce feelings of disgust for most people. Cockroaches also carry around hazardous germs. Thus, various traps have been manufactured and utilized in order to capture cockroaches.

FIG. 1 shows a conventional cockroach trap. The trap is comprised of a flat plate 100 and birdlime 110 on the plate 100. However, with such structuring of the cockroach trap, even if many cockroaches are caught on birdlime 110, a majority of them could escape if they constantly move. For example, when a cockroach trap having a plate (size of which is 200 mm*50 mm*1 mm) and birdlime 110 (size of which is 170 mm*25 mm) was installed in a confined space, fifty cockroaches were released and observed at a temperature ranging 27˜28° C. for 40 minutes, the results of which are shown in Table 1.

TABLE 1

| Captured | Escaped | Capture rate |
|---|---|---|
| 8 | 76 | 10% |

The above results show that it is impossible to capture cockroaches effectively with conventional cockroach traps. The cockroaches remaining on the birdlime 110 constitute only a small portion of those originally caught. Accordingly, the use of a conventional cockroach trap for the purpose of obtaining accurate statistical data regarding cockroaches' activities was not appropriate. For example, a room or a kitchen in a hotel requires an extremely sanitary environment without any cockroaches. If there is even a single one, it should be monitored and exterminated immediately. However, with the conventional cockroach trap, the number of existing cockroaches could not be monitored accurately, which makes it difficult to take suitable pest control measures at appropriate times. If cockroaches are not monitored immediately, then pest control measures are typically taken too late (i.e., after the cockroaches have rapidly increased in numbers). Consequently, the increased cockroaches cause feelings of disgust and it is very costly to get rid of them, which can lead to problems such as loss of sales in commercial stores.

In addition, to use the conventional trap for monitoring the cockroaches, the service technician had to visit every site where a trap is installed in order to examine the trap. As such, it was not feasible to immediately detect the cockroaches, thus resulting in waste of human resources since the service technician had to visit the trap sites for check-up even if there weren't any cockroaches. It is also impossible to know the exact time of capture, making it unrealistic to spray a proper amount of pesticides based on the status of cockroaches' emergence.

### DISCLOSURE OF THE INVENTION

The object of the present invention is to provide a cockroach trap that is appropriate for monitoring cockroaches so as to solve the drawbacks of the conventional cockroach trap.

More particularly, the present invention intends to provide a cockroach trap with an improved capture rate.

In addition, another object of the present invention is to provide a cockroach trap for effectively attracting the cockroaches using their natural behaviors.

Also,the present invention has yet another object of providing a remote monitoring system in order to monitor the capturing of cockroaches in remote places.

In accordance with an embodiment of the present invention, there is provided a cockroach trap, comprising: a plate; a first birdlime adhered to at least a portion of the plate; a slant having an inclined plane and a vertical section, the slant being disposed on the plate and adjacent to at least a part of the first birdlime; and a second birdlime adhered onto the vertical section.

In accordance with another embodiment of the present invention, there is provided a cockroach trap, comprising: a plate; a first birdlime adhered to at least a portion of the plate; a protruding part including at least one strip located on the plate and adjacent to at least a part of the first birdlime; and a second birdlime adhered to side walls of the strip adjacent to the first birdlime.

In accordance with another embodiment of the present invention, there is provided a cock roach trap assembly including one or more cockroach traps, wherein at least one of the traps comprises: a plate; a first birdlime adhered to at least a portion of the plate; a slant having an inclined plane and a vertical section, the slant being disposed on the plate and adjacent to at least a part of the first birdlime; and a second birdlime adhered on the vertical section.

### BRIEF DESCRIPTION OF DRAWINGS

FIG. 1 is a perspective view of a conventional cockroach trap.

FIGS. 2 and 3 are a disassembled perspective view and a perspective view, respectively. of a cockroach trap according to a first embodiment of the present invention.

FIG. 4 is a schematic view of a capturing part of a cockroach trap according to the first embodiment of the present invention.

FIG. 5 is a sectional view along IV-IV line of FIG. 3.

FIG. 6 is a sectional view of a cockroach trap according to a second embodiment of the present invention.

FIG. 7 is a perspective view of a capturing part of a cockroach trap in accordance with a third embodiment of the present invention.

FIG. 8 is a sectional view along IV-IV line of FIG. 6.

FIGS. 9 and 10 is a disassembled perspective view and a perspective view, respectively, of a cockroach trap having a sensor and a detected data processor in accordance with a fourth embodiment of the present invention.

FIG. 11 is a schematic top view of the cockroach trap having a sensor and a detected data processor of FIG. 9.

FIG. 12 is a sectional view along X-X line of FIG. 10.

FIG. 13 is a sectional view of a cockroach trap having a sensor and a detected data processor in accordance with a fifth embodiment of the present invention.

FIG. 14 is a perspective view of the capturing part of a cockroach trap having a sensor and a detected data processor in accordance with a sixth embodiment of the present invention.

FIG. 15 is a sectional view of the capturing part along XIII-XIII line of FIG. 14.

FIG. 16 is a schematic top view of capturing parts when a plurality of cockroach traps having a sensor and a detected data processor are connected.

FIG. 17 is a schematic diagram of the entire system, to which the detection signal by the cockroach trap having a sensor and a detected data processor is transmitted.

FIG. 18 is a schematic diagram showing the relationships among the cockroach trap having a sensor and a detected data processor, repeaters, a remote control unit and a central control unit in accordance with an embodiment of the present invention.

FIG. 19 is a diagram showing an example of sectioning in accordance with an embodiment of the present invention.

FIG. 20 is a block diagram showing a remote control unit in a remote monitoring system of FIG. 17.

FIG. 21 is a block diagram showing a central control unit included in a remote monitoring system of FIG. 17.

FIG. 22 is a table showing the analysis of cockroaches'activities in a sub-section.

FIG. 23 is an alarm table used by pest control timing decision module to decide when to proceed with the pest control measures.

FIG. 24 is an application table for selecting a table depending on a sub-section code.

FIGS. 25 and 26 are diagrams showing reports prepared by a central control unit of the remote monitoring system in FIG. 17.

FIG. 27 is a flow chart showing major operations of a remote control unit in the remote monitoring system.

FIG. 28 is a flow chart showing major operations of a central control unit in the remote monitoring system.

FIG. 29 is a schematic diagram of the remote monitoring system in accordance with an embodiment of the present invention.

FIG. 30 is a schematic diagram of the central control unit.

FIG. 31 is a schematic diagram of the remote monitoring system in accordance with another embodiment of the present invention.

FIG. 32 is a block diagram showing the remote control unit of the remote monitoring system in FIG. 31.

FIG. 33 is a perspective view showing a cockroach trap in accordance with another embodiment of the present invention.

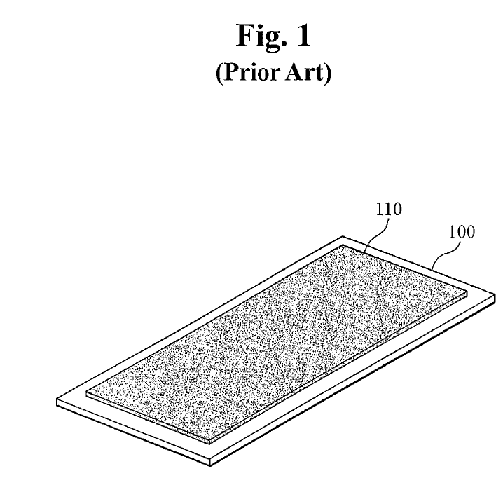

### BEST MODE FOR CARRYING OUT THE INVENTION

The present invention is directed to an improved cockroach trap, a cockroach trap having a sensor and a remote monitoring system using the same. Detailed explanations of each embodiment will follow in view of the accompanying figures. In the drawings, each of the components will be referred to using their corresponding numerals.

Improved Cockroach Trap

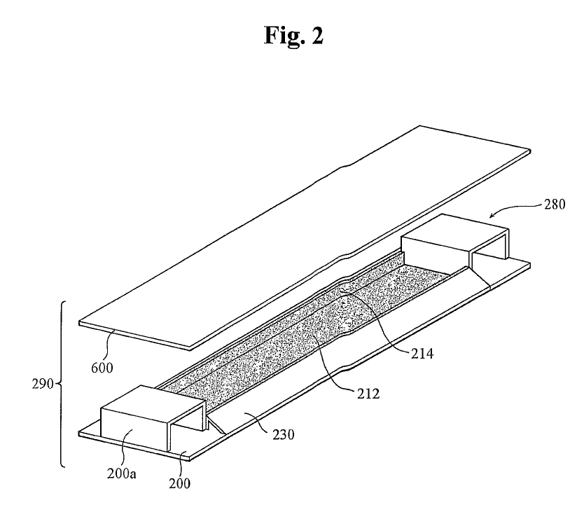

A cockroach trap will be described in view of FIG. 2 through FIG. 7.

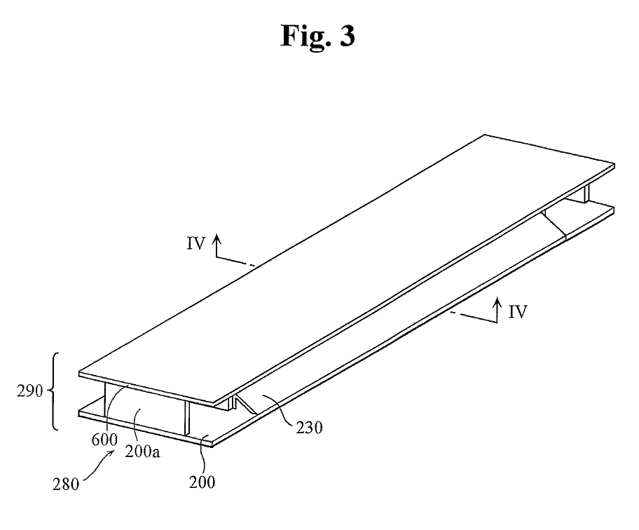

FIGS. 2 and 3 are a disassembled perspective view and a perspective view, respectively, of the cockroach trap constructed in accordance with a first embodiment of the present invention.

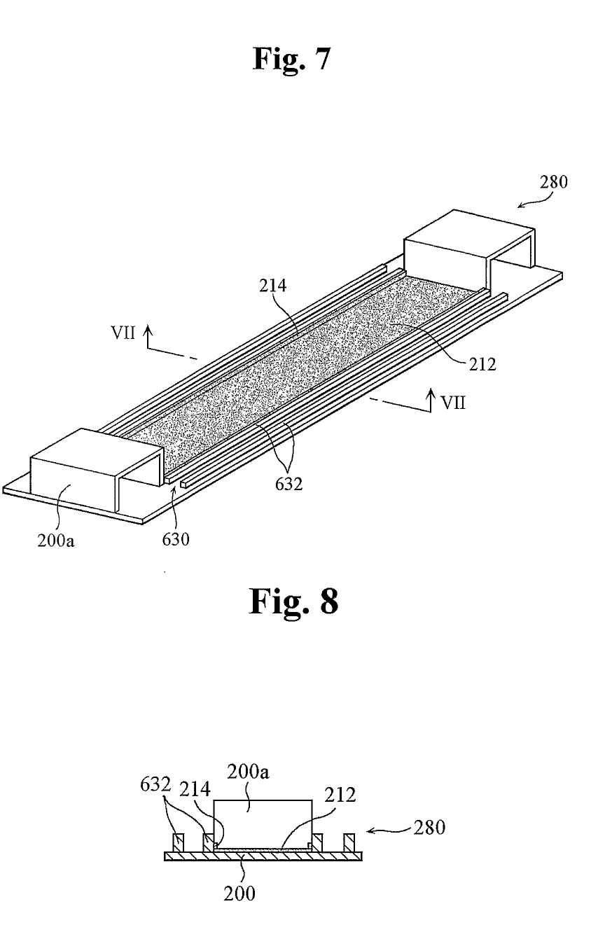

The cockroach trap 290 according to the first embodiment of the present invention comprises a capturing part 280 and a cover 600 installed on the capturing part 280. The capturing part 280 includes a plate 200, two slants 230 installed on the plate, birdlime 212 and 214 attached to the plate and the slant, and a supporter 200A. The capturing part 280 captures cockroaches with the slant 230 and birdlime 212 and 214 and supports the cover 600 on top with the supporter 200A. The cover 600 makes the interior of the trap obscure and forms a gap (700 in FIG. 7) between the slant and the cover to induce cockroaches into the trap. Each components of the cockroach trap according to the first embodiment will be explained in detail hereafter.

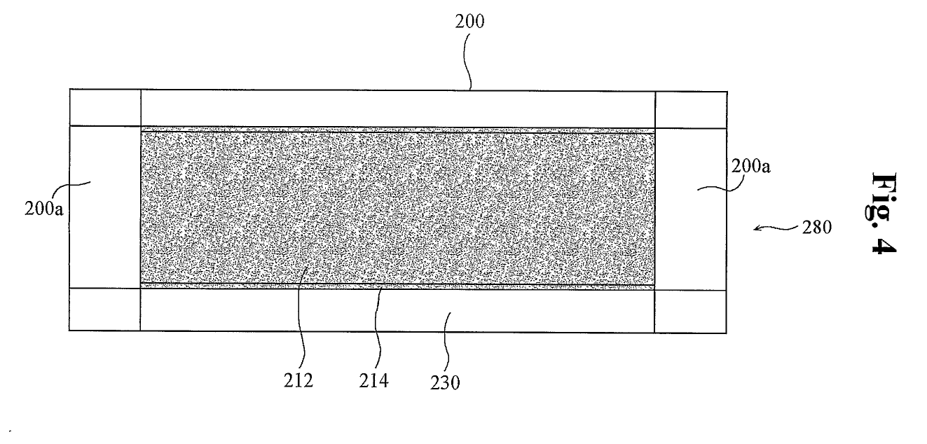

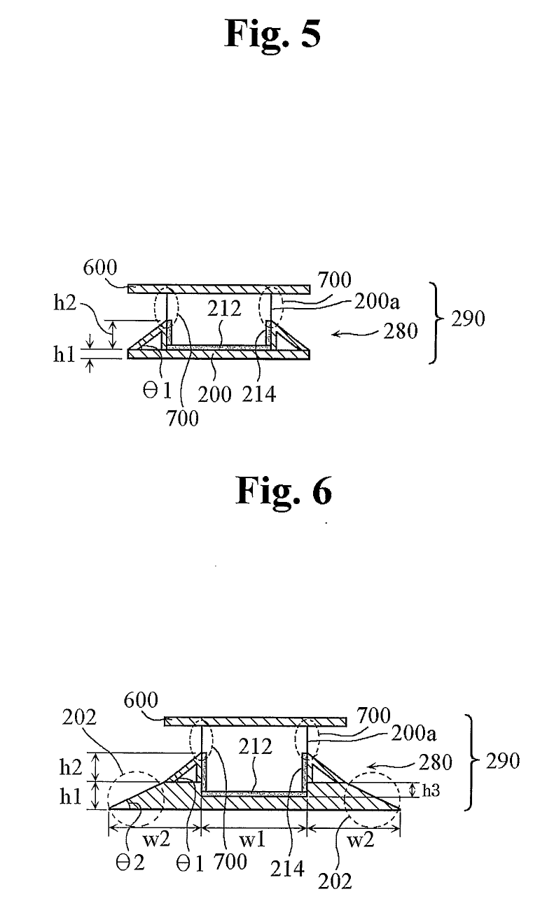

FIG. 4 is a schematic top view of the capturing part of the cockroach trap according to the first embodiment, while FIG. 5 is a sectional view of the cockroach trap along IV-IV line in FIG. 3. Detailed explanations will be provided in the order of the plate 200, the slant 230 and birdlime 212 and 214, which are included in the capturing part 280.

It is preferable to fabricate the plate 200 with materials that are sufficiently rigid to retain its shape. More preferably, the plate can be made from plastic, such as acryl, due to its endurance or convenience in transporting or installing the trap. If the thickness of plate 200, h1, is too large, then it is difficult for the cockroaches to climb up the slant 230 to go inside the trap. However, if h1 is too thin, then the plate made out of acryl could break.

Accordingly, the thickness of the plate 200 should be decided appropriately. The size of the plate 200 should be decided based on its usage or place of use. For example, a place where there is relatively a large number of cockroaches would need a wide plate 200. However, a place with relatively a small number of cockroaches would be fine with a narrow plate 200. The first birdlime 212 should be attached to the plate 200 between the two slants 230 installed on the plate. Also, the supporter 200A is formed on the plate 200 and the supporter 200A is assembled with the cover 600 to support the cover 600. The supporter can be made from the same material as the plate 200 and can be integrated with the plate. Or, it can be made separately and be attached to the plate 200.

The slant 230 functions so as to make it easy for cockroaches to enter the inside of the trap, but to difficult to escape. The term “inside of trap” used herein refers to the area between the slants 230 where the first birdlime 212 is placed. The slant 230 could be made of acryl or other materials that is durable and easy to manufacture. The slant 230 includes an inclined plane 232 and a vertical section 234. The height of the vertical section 234, h2, and the degree of the inclined plane's angle, slant angle θ1, are decided based on the attraction rate and capture rate of the cockroaches. The “attraction rate” refers to the ratio of the number of cockroaches, which had contact with the plate 200 or the slant 230, to the number of cockroaches that go over the slant and enter into the trap 290. The “capture rate” refers to the ratio of the number of cockroaches that entered the trap 290 to the number of cockroaches that entered and could not escape from the trap 290. High vertical section 234 of the slant 230 will increase the capture rate. However, if the vertical section is too high, then it may decrease the attraction rate. Thus, the slant angle should be decided properly.

The cockroaches tend to scud around and such behavior is well known to service technicians. The cockroaches run without any hesitation. According to a preferred embodiment of the present invention, such scudding behavior of the cockroaches is considered when deciding the thickness of the plate 200 and the shape of the slant 230. The cockroach scudding into the trap 290 is captured not on the edge, but at the center of the first birdlime, thereby significantly lowering the possibility of escape. In particular, if the plate 200 is too thick or the slant 230 is too steep, then the cockroaches running toward the trap 290 cannot run over the slant, which slows the scudding speed down. In such case, since the cockroach enters the trap 290 at a slower speed, only parts of the body (some parts of its legs) get stuck to the edge of the birdlime while other parts of the body are free, which allows the cockroach to try to escape. This increases the possibility of escaping from the trap 290. To determine the structure for encouraging the scudding nature and improving the capture rate, (i.e., to appropriately decide h2, the height of the vertical section 234, and slant angle of the slant 230), experiments were conducted to measure the attraction rate and the capture rate, while changing height h2 and slope of the slant 230.

Table 2 provides the test results showing the effect of the slant angle on the attraction rate, which is measured with the height of the vertical section 234 on the slant 230 fixed while varying the slant angle. Also, table 3 provides the test results showing the effect of the height of the vertical section 234 on the capture rate, which was measured with the base width of the slant 230 fixed while varying the height of the vertical section 234.

TABLE 2

| | Cockroaches | | |
|---|---|---|---|
| Slant angle | Touching the | Cockroaches Entering | Attraction |
| (°) | Plate (Number) | the Trap (Number) | rate (%) |
| 60 | 86 | 30 | 34.88 |
| 30 | 57 | 21 | 37.50 |

TABLE 3

| Height of the | Cockroaches | Cockroaches Escaped | |
|---|---|---|---|
| Vertical | Entering the | from the Trap | Capture |
| Section (mm) | Trap (Number) | (Number) | rate (%) |
| 8.7 | 38 | 11 | 71.05 |
| 2.9 | 24 | 20 | 16.67 |

From table 2, the relationship between the attraction rate and the structure of the trap 290 is as follows. As the slant angle becomes larger, cockroaches frequently turn back without entering the trap due to the steep inclined plane 232 of the trap 290. This is even if they touch the plate 200 or the inclined plane 232 of the trap. Therefore, the attraction rate goes down. With respect to the capture rate, as the height of the vertical section 234 becomes larger, the cockroach which entered the trap has to overcome the higher height, which improves the capture rate. To improve both properties, one should increase the size of the slant to increase the height of the vertical section, which relates to the attraction rate, while fixing the slant angle of the inclined plane, which relates to the capture rate. However, this results in longer inclined plane 232 of the slant 230, which makes the cockroaches that are starting to climb up the slant 230 to turn back instead of entering the trap 290. More specifically, due to the length of the inclined plane 23e, even if the slant angle is maintained the same, the capture rate goes down. When considering the attraction rate and the capture rate, the slant angle of 30° for the inclined plane 232, θ1, and 5 mm height of vertical section of the slant have been employed in an embodiment of this invention.

In relation to the birdlime, in a preferred embodiment of the invention, the first birdlime 212 is placed between the slants 230 on the plate 200, while the second birdlime 214 is placed on the vertical section 234 of the slant 230 (refer to FIG. 2 & FIG. 5). The second birdlime 214 is attached on the vertical section 234 of the slant 230 by using a two-sided adhesive tape. By attaching the second birdlime 214 on the vertical section 234 of the slant 230, the escape of the cockroaches that entered the first birdlime 212, which are trying to escape by going over the vertical section 234 of the slant 230, can be prevented. Also, when the cockroach enters the trap 290 with a part of its body lying on the slant 230, its body or the legs could get caught on the second birdlime, which results in an increase of the capture rate. For instance, a cockroach climbing the inclined plane 232 of the slant 230 tends to hesitate at the crest of the inclined plane 232. Accordingly, the body of the cockroach may not entirely enter the first birdlime 212 but partly lies over the vertical section 234. For example, only two of the cockroach's six legs could be stuck on the first birdlime 212. In such case, as the second birdlime 214 is attached to the vertical section 234 of the slant 230, a part of the cockroach is caught by the second birdlime 213, thus improving the capture rate. The birdlime 212 and 214 can be made of an adhesive composed primarily of poly-butane, for example. As long as a certain level of adhesive strength is maintained, other materials can be used as well. Applying birdlime, which has a greater strength, is recommended for improving the capture rate. Furthermore, placing attractants such as pheromone, food, dead cockroach, excrement or other well-known inducing agents can enhance the attraction rate of the cockroaches.

Referring to FIGS. 2A and 2B, the capturing part 280 and the cover 600 will be explained. The cover 600 is disposed on the top of the supporter 200A and can be separated from the supporters. For instance, it can be installed by using bolts so that it can be assembled/disassembled. Other methods for stably supporting the cover 600 can be used such as designing a portion of the cover 600 and a portion of the plate 200 in a manner such that they can be fitted to each other without the use of bolts.

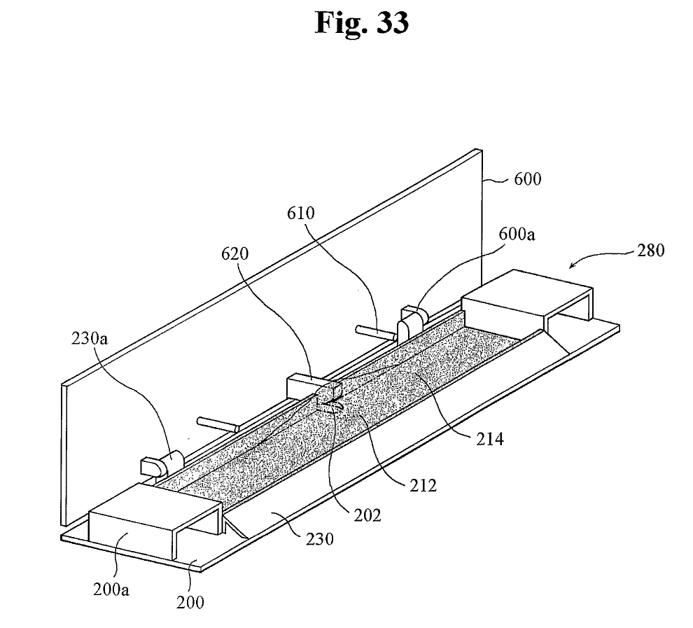

The structure of the cover 600 is not limited to the structure shown in FIG. 3. It could also be arranged such that one end of the cover 600 is connected to the slant 230 of the capturing part 280 as shown in FIG. 33, which enables the rotation of the cover. By installing the rotatable parts 230A and 600A on the cover 600 and one of the slant 230 of the capturing part 280, the capturing part 280 and the cover 600 can be rotatably connected. Also, if several pushing bars 610 are installed on the bottom of the cover 600, then birdlime can be steadily fixed and not be detached from the plate. This is because the pushing bar 610 pushes the first birdlime 212 when the cover 600 covers the capturing part 280.

In other words, by attaching a pushing bar 610 that is long enough to touch the plate 200 of the capturing part 600 at the end of the bottom of the cover, the birdlime is pushed by the pushing bar 610 when the cover 600 is covering the capturing part 280. In addition, a birdlime removing bar 620 can be installed on the base of the cover 600 to facilitate the removal of the birdlime. In cases of installing the removing bar 620, a groove 202 is formed at the corresponding location on the slant 230 and the plate 200. When the cover 600 covers the capturing part 280, the removing bar 620 will be fitted into the groove. As the cover 600 rotates to be detached from the capturing part 280, the removing bar 620 will rotate out of the groove 202. As the removing bar 620 rotates, the first birdlime 212 on the plate 200 is lifted up by the removing bar 620. If too many cockroaches are captured or the stickiness of the birdlime becomes degraded over time, then the birdlime has to be replaced. According to the embodiment, when the cover 600 is opened, the first birdlime 212 is lifted up, thereby making the replacement convenient.

A gap 700 is created between the cover 600 and the slant 230 due to the cover 600, which obscures the interior of the trap 290. It is well known fact that the cockroaches are fond of dark environments and thin gaps. As such, the present structure should attract more cockroaches. Generally, the cockroaches are most attracted when the gap 700 is between 7 mm to 10 mm. An appropriate width of the gap can be decided according to the types of cockroaches. Therefore, having the cockroach trap 290 with an additional cover 600 that makes the gap 700 according to the embodiment of the invention will increase the number of captured cockroaches. The cover 600 can be modified so as to make the gap in a preferred form. For example, if the portion of the cover 600 above the slant 230 is slanted so as to become parallel to the inclined plane 234 of the slant 230, the gap is formed along the entry route of the cockroach trap so that the cockroach trap will have a superior attraction rate. In other embodiments, the portion of the cover 600 that is near the crest of the inclined plane 234 is protruded downward, (in other words, the protruding portion may be attached to the cover in a normal or slant downward direction of the cover,). In this structure, when a cockroach reaches the crest of the inclined plane 232, antennas of the cockroach can touch the protruding portion of the cover 600. Since some objects are detected by the antennas when the cockroach reaches the crest of the inclined plane 234, the cockroach may have an illusion that the floor (i.e., inclined plane) continues and proceeds forward. The capture rate of the cockroach was measured with the above-described embodiment of the present invention, which shows the following test results. The experiment was conducted by placing the cockroach trap 290, which is in accordance with the embodiment, in a confined space, and the observation was made for 40 minutes in a temperature of 27˜28° C. with 100 cockroaches released in the space. A 200 mm*50 mm*1 mm size plate 200, a 5 mm high vertical section, 13 mm long inclined plane 232 of slant 23,0 and the first birdlime 212 area of 170 mm*25 mm was used for the cockroach trap 290 in the experiment.

TABLE 4

| Captured | Escaped | Capture rate |
|---|---|---|
| 37 cockroaches | 9 cockroaches | 75% |

The above test results indicate that a total number of 46 cockroaches were captured, but 9 of them have escaped, thus making the capture rate 75%. As can be seen from the experiment, when compared to the capture rate of the conventional cockroach trap 290 (10% according to table 1), it is evident that the cockroach trap 290 of the present invention has prominently improved the capture rate.

FIG. 6 is a sectional view of the cockroach trap constructed in accordance with a second embodiment. The difference between the first and second embodiments lies in that the central part, w1, of the plate 200 is more subsided than the periphery part, w2, where the slant 230 is attached. Thus, the height, h2, of the inclined plane 232 of the slant 230 can be relatively increased by the subsided depth, h3. The cockroach that entered the trap 290 has to overcome the height of h2+h3 in order to escape, which makes it harder to get away. The thinness of the subsided central part w1, i.e., (h1−h3), can be approximately 0.5 mm. The thickness of the periphery part w2, h1, where the slant 230 is installed h1, can be approximately 3 mm. Since the central part of the plate 200 is subsided in the second embodiment, the plate unit 200 may be formed thicker than that of the first embodiment in order to prevent damage in wI part of plate 200. To improve the capture rate of cockroaches in the second embodiment, the depth of the subsided part, h3, should be increased as much as possible by thickening w1, the thickness of plate 200. However, this could lower the attraction rate of cockroaches. According to an embodiment of the present invention, the problem associated with low attraction rate can be settled by attaching a gentle slope at the end of the plate 200. In other words, as shown in FIG. 6, among the four sides of the plate 200, the two sides, along which the slants are installed, are inclined with angle of θ2. Therefore, the cockroach can enter the trap easily. The trap shown in FIG. 6 has the gently inclined plane at the end of slant, while the two sides of the trap shown in FIG. 5 has a perpendicular plane of height h1. This structure improves the attraction rate since it is easier for cockroaches to climb up an inclined plane than a perpendicular plane. In the embodiment, the slope of the slant 230, θ1, is 30° but the slope at the end of plate 200, θ2, is 15°. A gentler slope at the end of the plate 200 will make it easy for the cockroach to approach the trap. Once it has climbed up the plate 200 with 15° slope, it will climb the slant 230 with slope of 30° more easily since the difference in slant angle is only 15°. Also, the scudding behavior of the cockroach will likely keep it running, thereby enhancing the possibility of entering the trap. The cockroach has to overcome a greater height in order to escape the trap 290 in the second embodiment. Thus, the capture rate is higher than the first embodiment.

The structure with the inclined end of the plate 200 not only applies to the second embodiment but also to the first embodiment. That is, the subsided central part and the inclined end of the plate can be used either independently or simultaneously. Also, the inclined plane 232 can be made to have a multi-step structure such as two or three steps of different slant angles. It can also be made in the form of a curved surface with gradually changing angle. In this case, the slant angle of the inclined plane at the end of the slant can be made small, whereas the height of the vertical section 234 can be made high. This is expected to improve the attraction rate and the capture rate.

The traps according to the first and second embodiments use the slant to improve the capture rate. However, it should be noted herein that other structural elements can be used for enhancing the capture rate.

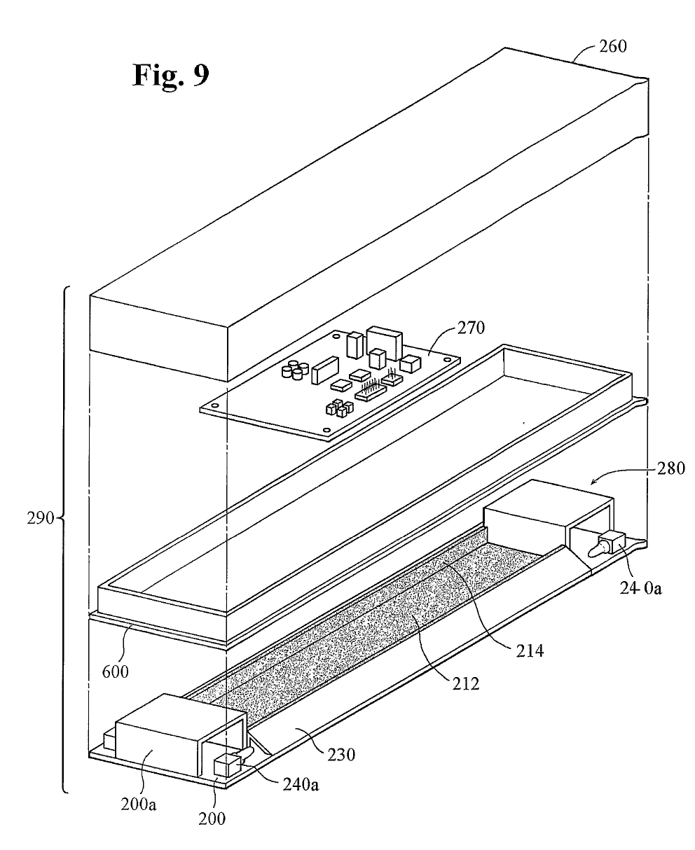

FIG. 7 is a perspective view of the capturing part of the cockroach trap, which uses a protruding part instead of the slant of the first embodiment, according to the third embodiment. FIG. 9 shows a cross section of such capturing part.

The third embodiment of the present invention has a protruding part 630 instead of the slant. The protruding part 630 is installed in the entrance route of the cockroach trap. The protruding part 630 comprises a plurality of strips 632. For example, the protruding part may have two stripes 632 at each side as shown in FIG. 7 and FIG. 8. The strip 632 can be made of acryl and glued to the plate 200 by adhesive or can be integrated with the plate 200. However, it should be expressly stated herein that the material and production method of strips are not limited to the above as others may be used in lieu thereof. The height of the protruding part 630, h3, should be decided by considering the attraction and the capture rates of cockroaches. As explained above, the capture rate will increase as h4, the height of the protruding part 630, becomes higher. However, the attraction rate will decrease. Thus, such relationship between the two rates should be considered.

As for the birdlime, the first birdlime 212 should be placed on the plate 200 and the second birdlime 214 should be placed on the wall surface of the strip 632 of the protruding part 630 near the first birdlime 212. The second birdlime 214 prevents the cockroaches from escaping the trap so as to enhance the capture rate as in the first and the second embodiments.

Up to now, the structures, such as the one shown in the first or third embodiment, installed the slant 230 or the protruding part 630 on the two sides of the first birdlime. However, the cockroach trap according to the present invention is not limited to such structuring. The slant 230 or the protruding part 630 can be installed along the four sides of the first birdlime so as to surround the first birdlime 212. Also, the particular structure, such as the slant 230 or the protruding part 630, could be modified while maintaining the attraction and capture rates as well as the configuration of having the birdlime on the sidewalls. For example, the height, grade of the slant, number of strips, height and width of the strip can be modified.

Cockroach Trap with a Sensor

The embodiment of the cockroach trap with a sensor will be explained in view of FIG. 9 through FIG. 14. The basic structure of the trap is same or similar to the trap, which was explained with reference to FIG. 2 or FIG. 8 (except for the installation of additional sensor and data processor). Thus, the above trap will be explained by focusing on the sensor and the data processor without repeating the details previously explained.

FIGS. 8A and 8B are a disassembled perspective view and a perspective view, respectively, of the cockroach trap constructed according to the fourth embodiment and having the sensor and data processor added to the first embodiment.

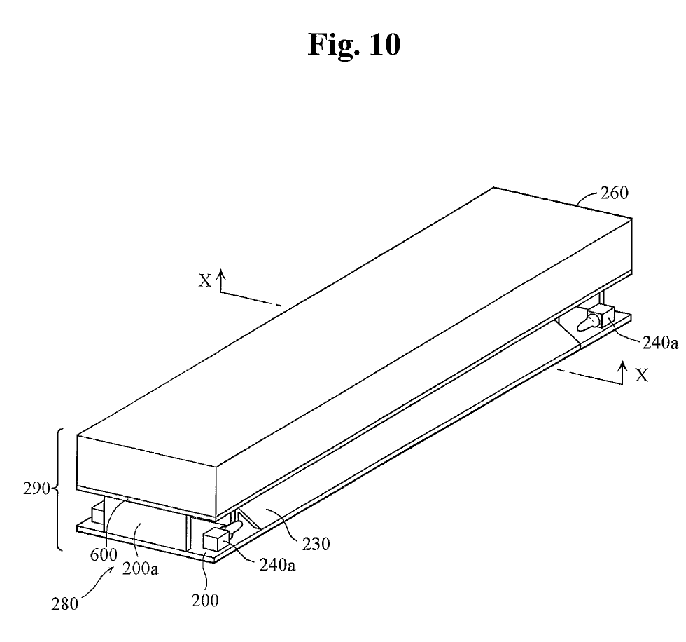

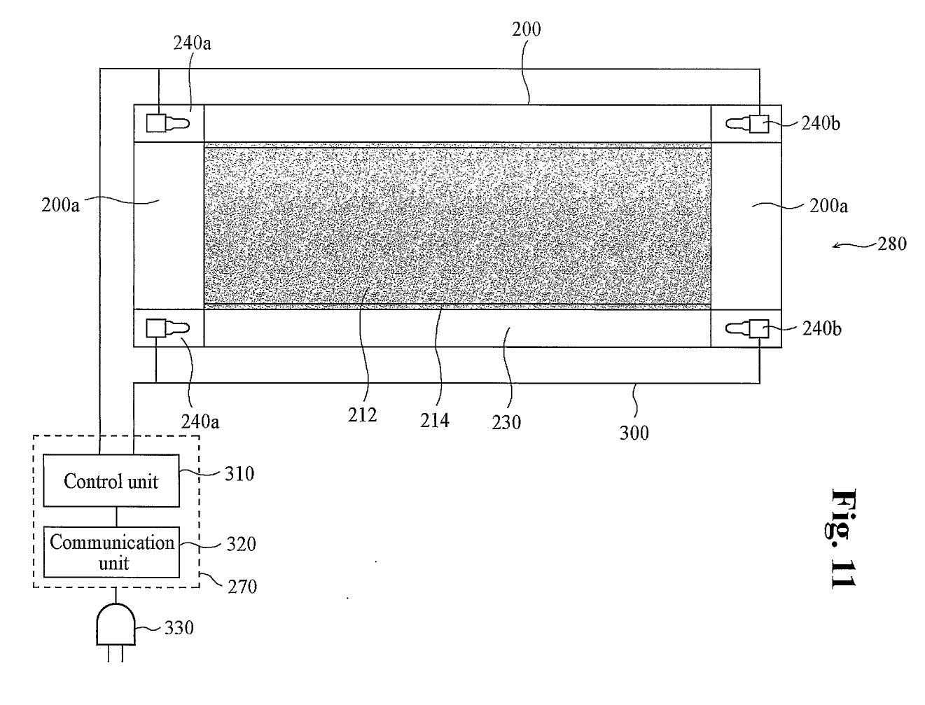

In the cockroach trap 290 of the fourth embodiment of the present invention, the sensors 240A and 240B are installed near both ends. The sensors 240A and 240B are used to count the cockroaches entering the capturing part 280 (i.e., towards the birdlime). The data detected by the sensors 240A and 240B are transmitted to the data processor 270 by a line (not shown) to count the numbers of cockroaches that entered the trap 290. The data processor 270 counts the cockroaches by using the information transmitted from the sensors 240A and 240B. Over the plate 200, a case 260 covering the entire cockroach trap will be disposed to protect the data processor 270 from external forces (as shown in FIG. 10).

Hereafter, the cockroach trap 290 with the sensors 240A and 240B according to the fourth embodiment of the present invention will be explained in detail.

FIG. 11 is a schematic top view of the cockroach trap of the fourth embodiment in which the data processor 270 is connected to the sensors 240A and 240B.

As illustrated in FIG. 11, the sensors 240A and 240B are installed on the plate 200 near both ends of the slant 230. The sensors 240A and 240B should be installed so that the ray of light incident from a light-emitting unit 240A to a light-receiving unit 240B minimally interferes with the slant 230. In order to completely prevent any interference between the sensors 240A and 240B and slant 230, the sensors 240A and 240B have to be installed outside of the line of the slant extended along the slant, which makes the plate too wide. Therefore, when considering the size of the trap 290, the sensors 240A and 240B should be positioned appropriately so that only a part of the light interferes the slant 230. FIG. 9 illustrates this case in which the light emitted from the light-emitting unit 240 overlaps partly with the slant 230.

In the embodiment of the present invention, the infrared-light sensor can be used. Further, a set includes the light-emitting unit 240A and the light-receiving unit 240B. According to the preferred embodiment of the present invention, two sets of the sensors are installed in the trap 290. Each sensor is connected to the data processor 270 through lines. The lines for the sensors 240A and 240B can be placed on the plate 200 under the first birdlime 212 and are connected to the data processor 270 through a hole made on the cover 600. Although the infrared-light sensor is described above, other sensors such as ultrasonic sensor, laser sensor and electrostatic capacity sensor can also be used.

When a cockroach enters the trap 290 by crossing over the slant, the cockroach is identified by the sensors 240A and 240B and the data processor 270 uses this data to count the cockroaches. Thus, the total number of cockroaches entering the trap 290 is counted. If the infrared sensor is used as the sensors 240A and 240B, then an ambient light could interfere and cause errors in counting the cockroaches. For instance, the amount of ray of light incidence to light-receiving unit 240B in daytime is basically larger than the nighttime. Although the cockroach did not enter the trap 290, changes in the ambient light and outside environment can result in an error of counting cockroach entrance. Therefore, the critical value of the light-receiving unit 240B should be adjusted appropriately in order to prevent any errors in counting. A control unit 310 using a timer is included inside the data processor 270. The unit is programmed such that at daylight the critical value is set high considering the light around the cockroach trap 290 and at nighttime critical value is set lower than the daytime.

Even if the critical value of the light-receiving unit 240B of the infrared sensor is adjusted, the number of cockroaches counted is not the total number of cockroaches captured since the capture rate of cockroach trap 290 is not 100%. Programming the control unit 310 that considers the capture rate of cockroaches can solve this problem. For example, if the capture rate of the cockroach trap 290 is 33%, this means that two out of three cockroaches have escaped from the cockroach trap 290 after entering. Therefore, the control unit 310 should be programmed so that three cockroaches detected in the sensor 240A and 240B should be counted as one. By programming the control unit in this method, the embodiment of the present invention can count the captured population of the cockroaches approximately.

In the embodiment of the present invention, one set of the slants 230 are installed on both sides of the first birdlime 212, while the sensors 240A and 240B are installed near the end of each slant 230. Thus, the entering direction of the cockroach can be monitored and such data can be used for deriving useful data such as the habitat. For instance, if several cockroach traps 290 are in use, the data such as the location of each trap 290, the capture rate of each trap 290 and the entering direction in each trap 290 can be used to analyze useful information such as the habitat and movements of cockroaches.

Next, the data processor 270, which is marked in dotted line in FIG. 11, includes a control unit 310 and a communication unit 320. The control unit 310 counts the cockroaches by using the data transmitted by the sensors 240A and 240B and produces detected data such as sensor identification data and count information. The identification data includes data denoting either the left or right sensor to the first birdlime 212 and unique identification number of the trap 290. The unique identification number is assigned to each trap to distinguish the traps. Also, the identification data can be used to figure out the habitat, which is helpful for finding the routes of the cockroaches. The count information is the total population of the detected cockroaches and when it is over a certain threshold, pest control measure is needed. The identification data and count information can be useful in planning the pest control measures. In other words, data denoting how many cockroaches had entered in which direction can be generated by using the trap with a sensor, the information of which can be used for pest control planning. The data processor 270 receives power from the power unit 330, such as a battery or an AC adaptor. The detection signal generated from the control unit 310 is transmitted to the communication unit 320. The communication unit 320 then transmits the detection signal to a remote control unit (to be explained later), which is installed in the monitored subject site (the targeted building where appearance of cockroach is monitored). The connection between the communication unit 320 and a central control unit (a central computer for summing up and processing data from each monitored subject) in a remote place can be directly made. Alternatively, they can also be connected through the remote control unit (the controller for managing multiple cockroach traps installed in one monitored target site) for ease of management if several cockroach traps are used in the same site. The remote control unit and the central control unit will be explained in detail later with respect to the remote monitoring system. For ease of installation, the communication unit 320 should be able to transmit the data wirelessly.

Up to now, transmitting the detection signal to a remote place or a separate computer was mainly explained. Instead of or in addition to such structure, a display (i.e., LED) can be installed in the trap so that the service technician can easily check the number of the captured cockroaches in the sites without opening the cockroach trap 290. Such display can also be used to indicate when to replace the birdlime 212 and 214 of the cockroach trap. When the display (i.e., the lighting-up LED) displays a predetermined signal denoting the replacement of the birdlime 212 and 214, the service technician visiting the site can replace the birdlime 212 and 214. Thus, the service technician does not have to open all the cover 600 of the cockroach traps 290 to decide whether to replace the birdlime 212 and 214, but can simply open the traps 290 with signals on, which obviously saves working time. In this case, making signals for the display of the cockroach trap 290 can be done from the central control unit at remote places. For this, the database at the central control unit maintains the data for birdlime replacement timing of each cockroach trap 290. The data for birdlime replacement timing includes the number of captured cockroaches and the previous records of birdlime replacement, based on which the next replacement timing is determined. The service technician searches relevant data and sends those data to the remote control unit of the monitored subject site before visiting the site. Then, when the service technician visits the site, he/she can verify from the display which cockroach trap 290 needs replacement of the birdlime.

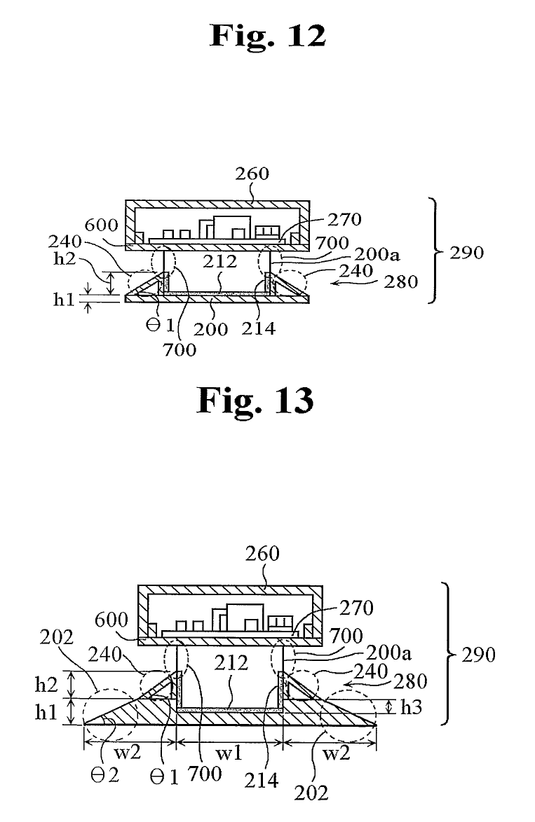

FIG. 12 is a sectional view of the cockroach trap along the X-X line in FIG. 10.

FIG. 13 is a sectional view of the cockroach trap having sensor in accordance with the fifth embodiment of the present invention. The difference between the fifth and fourth (FIG. 12) embodiments is that the plate is subsided at the center and inclined at the end. These structures are already explained with respect to the second embodiment and thus will not be explained again.

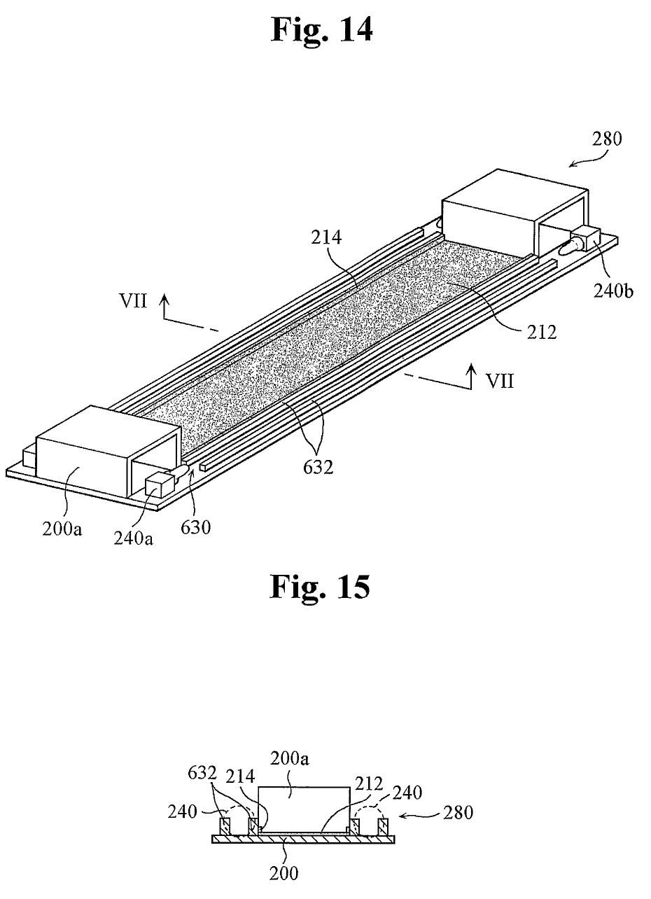

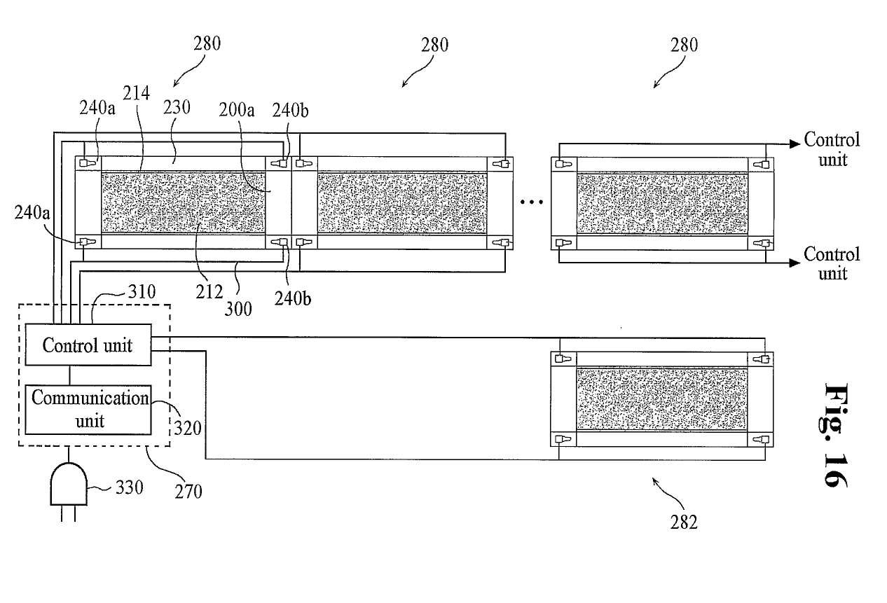

FIG. 14 and FIG. 15 illustrate a sectional view of the capturing part with a sensor and a detected data processor according to the sixth embodiment . FIG. 15 is a sectional view of the capturing part along VII-VII line in FIG. 14.

In the sixth embodiment, the entrance of the cockroach can be monitored through sensors installed near the both ends of the protruding part 630.

The slant 230 or the protruding part 630 can be installed along the two sides of the first birdlime as well as along the four sides, which means it can be installed so as to surround the first birdlime 212. In such case, two additional sensors can be installed for the slant 230 or the protruding part 630 for accurate monitoring of the cockroaches.

According to the embodiment explained above, the slant 230 or the protruding part 630 is installed with the birdlime in between, thus securing a detection area for the sensors 240A and 240B. If the sensor is installed without the slant or the protruding part as in the structure of the conventional cockroach trap, then the sensor could stop working in cases where the cockroach with two front legs, which are stuck on birdlime, pulls its body back to escape, thus encroaching upon the detection area of the sensor. If the space between the sensor and the birdlime is increased, then some of the problems could be resolved. However, the size of the cockroach trap will become larger, thus taking up too much space and degrading the appearance. In addition, the accuracy of the sensor will be low since there may be cockroaches that are detected by the sensors 240A and 240B but do not touch the birdlime 212 and 214. However, if the slant 230 or the protruding part 630 is built on both sides of the first birdlime 212 as in the embodiment of the invention, the possibility of encroaching upon the detection area of the sensor will be lower. This is even if the cockroach, which entered the cockroach trap 290, has two front legs stuck on birdlime and pulls its body back since the body lies across the crest of the slant 230 or the protruding part 630. Thus, the problems, such as counting one cockroach several times or not counting a cockroach entering the trap, will be effectively mitigated. The effect can be achieved not only with the slant or the protruding part but also with another structure (i.e., cylinder shape).

Up to now, one cockroach trap is explained. But, in reality, when capturing cockroaches or installing a trap for monitoring the captured amount of cockroaches, several traps need to be installed to cover a wide area. Multiple cockroach traps can be connected through making the two plates or two covers fitted with each other.

FIG. 16 is a schematic top view of multiple capturing parts 280 and 282 of the cockroach traps connected together. More specifically, when connecting several cockroach traps together (as illustrated in the upper part of FIG. 16), contacting the sides without the slant 230 of the plate 200 will extend the length of the cockroach trap 290. The lengthened cockroach trap 290 can be installed in a wide area, which will enable the capturing of a large number of cockroaches. To connect a series of traps 290, each trap 290 needs a coupling device (i.e., a protrusion on one side and a groove on the other side to fit the protrusion) at the cross section of the plate.

Although the cockroach traps 290 are connected together, installing only one or few data processors 270 is preferred to reduce cost and ease installation. CPU having multiple input ports is preferably used as the control unit 310. In such case, multiple sensors 240A and 240B can be connected to the control unit 310. Sensors of the remaining cockroach traps without the data processor 270 are wired to the cockroach trap 280 with the data processor 270 to connect multiple cockroach traps 290 to one processing unit 270. If the number of the sensor 240A and 240B is greater than the input ports provided by CPU due to the multiplicity of cockroach traps, CPU can be connected in a master-slave manner to extend the number of cockroach traps 290 in a chain. Even when connecting multiple cockroach traps 290 considering the area being monitored, by using CPU connected in such way, each sensor 240A and 240B can be identified and the count number of cockroaches detected from each sensor 240A and 240B can be collected.

The cockroach traps according to the embodiment will be installed in appropriate numbers to monitor the activities of cockroaches in designated places. Accurate monitoring is possible only when an appropriate number of cockroach traps is installed in proper locations. When connecting multiple cockroach traps 290 according to the embodiment of the present invention, two traps 290 can contact each other to be connected in series (FIG. 16, connection of 280), or one or more traps 290 are spaced apart but wired together (FIG. 16, connection of 282). The cockroach trap 290 connected in series can be installed in spacious and open places such as walls. A separately wired trap 290 can be placed (e.g., under the refrigerator) where wireless communication is difficult and the installation of the trap is not feasible. According to an embodiment of the present invention, among the connected cockroach traps 290, the data processor 270 is installed in a cockroach trap in open places and the trap 290 with the data processor 270 and a trap 290 installed in the inconvenient place is wired together. Following such structure, the data from the cockroach trap in a place where wireless communication is impossible and where the installation is inconvenient can be transmitted wirelessly through the detected data processor 270. Since places appropriate for installing the cockroach trap is well known in the industry, the detailed explanation will be omitted herein. According to an embodiment of the present invention, each trap can have a display, which indicates the number of the captured cockroaches and the replacement timing of birdlime. In structures shown in FIG. 16, the display of 282 (i.e., the display of trap out of sight) can be installed in the trap that is seen easily so that the technician can easily know the data of the unseen trap.

The trap 290 with the captured cockroaches is inspected during regular check-ups to decide the number of captured cockroaches. Or, the number of captured cockroaches is transmitted from the communication unit 320 to the central control unit in remote places. Such number can provide useful data for later pest controls. For example, if a large population of cockroach is captured, the data can be used to shorten the intervals of regular check-up.

Remote Monitoring System

Referring to the FIGS. 15 through FIG. 32, the remote monitoring system, which can monitor the activities of cockroach from remote places using the cockroach trap with the sensor, will be explained.

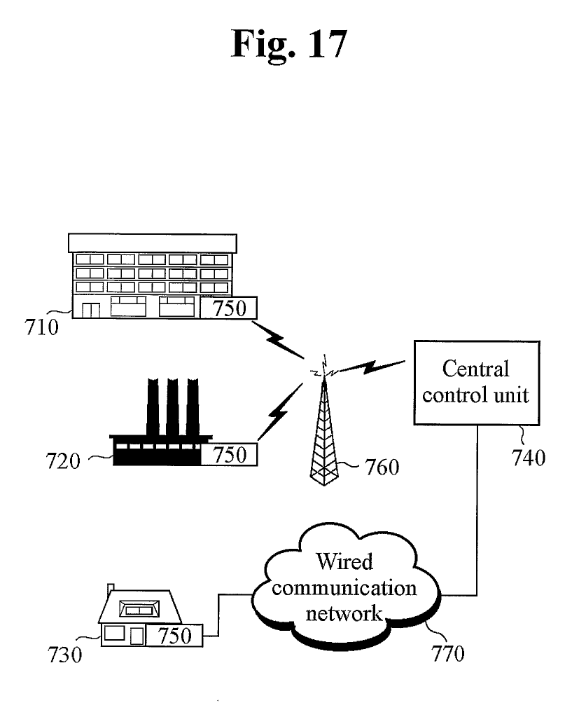

FIG. 17 is a schematic diagram conceptually illustrating the remote monitoring system for pest control according to the first embodiment of the present invention.

As illustrated therein, the remote monitoring system for pest control according to the embodiment of the invention includes the remote control unit 750, which is installed in a monitored subject site such as a building 710, 720 and 730, to keep a watch on the activities of cockroaches and to collect data on them. It then transmits the previously collected data through a wireless network 760 or wired network 770 such as Internet or general telephone lines. The remote monitoring system also includes the central control unit 740, which analyzes and manages the transmitted data. The monitored subject site means a building where cockroaches appears or is likely to appear, or any other predetermined spaces (e.g., public parks, places for loading freights, etc.), or an outer area of the building or the predetermined space.

The remote control unit 750, which is installed in each building 710, 720 and 730, monitors the activities of cockroaches and collects data such as the population of cockroaches invaded or captured, the invasion time, the invasion route and the invasion location (hereinafter, “pest-related information”).

The collected pest-related information is transmitted to the central control unit 740 in real time or periodically through the wireless communication network 760 or wired communication network 770. The communication network can be selected among a public switched telephone network, cables for high-speed Internet, and wireless local area network (LAN) according to the types and conditions of the sites 710, 720, and 730, in which the remote control unit 750 has been installed.

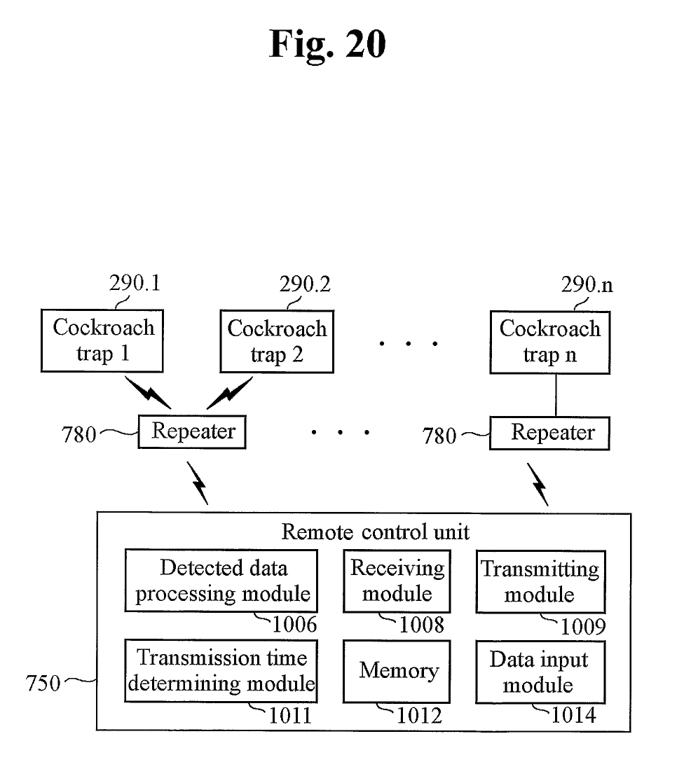

The central control unit 740 receives and analyzes the pest-related information transmitted from the remote control unit 750. Preferably, the pest-related information is analyzed to obtain information on, for example, the frequency of appearance and population of pest appearing or captured, based on predetermined analytic categories that are classified by buildings, positions in each building, times and dates, etc. Detailed descriptions on the analysis of the pest-related information will be made with reference to FIGS. 19 and 20. A pest control measure for each site is prepared based on the analyzed data in the central control unit 200. If it is decided that a pest control operation is required, then the service technician visits the subject site and performs the proper pest control operation based on the analyzed data.

The central control unit 740 generates secondary information, which is useful for pest control in, for example, appropriately determining a pest control time, by storing and updating the pest-related information in the database and analyzing it as needed. Hereinafter, the place at which the central control unit 740 is installed is called the “central control center.”

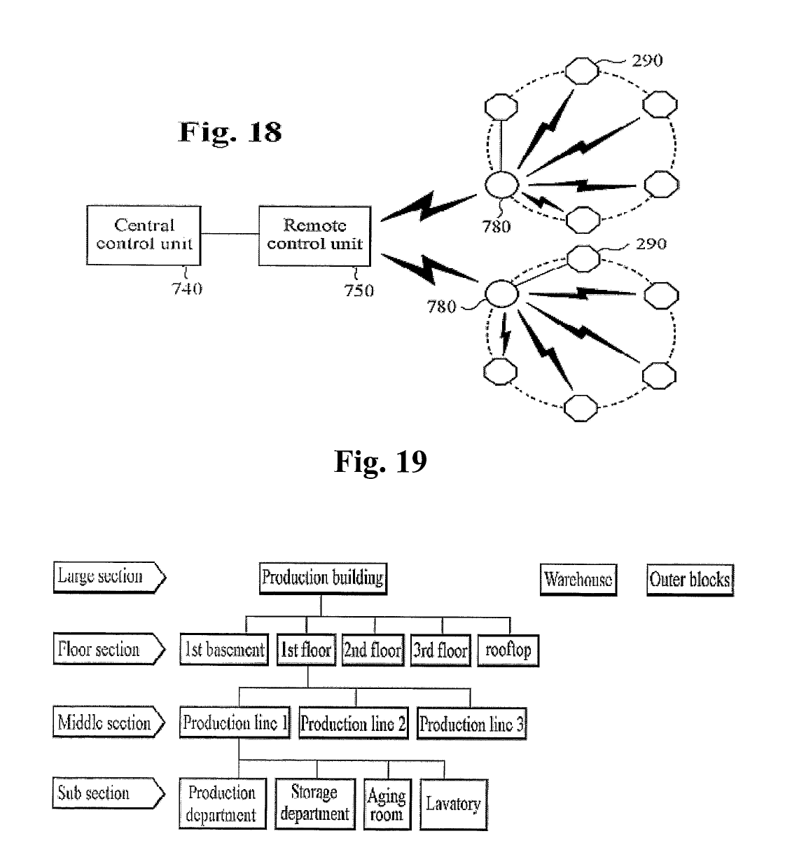

The interrelationship between the cockroach trap 290, repeaters 780, the remote control unit 750 and the central control unit 740 is illustrated in FIG. 18. The repeaters 780 are provided for effectively conducting wireless communications between the cockroach trap 290 and the remote control unit 750. Remote control unit 750 is configured such that a single repeater 780 is coupled to one or more cockroach traps 290 and remote control unit 750 is coupled to one or more repeaters 780. However, cockroach trap 290 does not have to be connected to the remote control unit 750 through repeaters 780 but can be directly connected to the central control unit 750. Additionally, in the figures, it is shown that each cockroach trap communicates with the repeaters 780. As explained earlier, if the cockroach trap 290 with the data processor is connected to several cockroach traps without the processor, then those traps do not communicate directly with the repeaters 780, but communicate with repeaters 780 through the trap 290 with the data processor.

In the present invention, to manage the pest-related information efficiently, a subject site in a remote place is sectioned into a plurality of sections. Sectioning herein means to hierarchically divide a subject site (including a building) into a plurality of sections according to the characteristics of the area. In one embodiment of the present invention, a four-stage sectioning is applied to a subject site. In the embodiment, the four-stage sectioning divides a subject site (e.g., an industrial complex as a whole) into: a large section including buildings in the industrial complex and their outer blocks; a floor section including each floor in the buildings; a middle section under the floor section; and a sub-section that is under the area of the middle section. The sub-section is a minimum unit of sectioning. However, if additional sections in the industrial complex need to be monitored, then the sub- section may be further sectioned. For example, as shown in FIG. 19, production buildings, warehouses, and outer blocks in a factory belong to the large sections; floors of the production buildings, such as 1^{st} basement, 1^{st} floor, 2^{nd} floor, 3^{rd} floor, and rooftop, belong to the floor group; production lines 1, 2 and 3 on each floor belong to the middle section; and a production department, a storage department, an aging room, and a lavatory in each of the production lines belong to the small section. Those sections are the fundamental units (typically, sub-sections are the minimum units for pest control) for pest control and pest control measures, and are used for analysis and management of pest-related information. For example, analyzing the progress of pest outbreak and effectiveness of pest control is performed on each production line belonging to the middle section to produce the pest-related information. An appropriate pest control measure and control equipment are prepared for each production line by using the pest-related information when reforming or increasing the production lines.

A sub-section code is assigned to each sub-section. Each facility in a remote place is classified and the sub-section codes are assigned thereto based on the functions of sub-sections and/or tendency of the pest outbreak thereof. If sub-section codes of different sub-sections are identical to each other, then a similar tendency of pest outbreak would be expected in such sub-sections. For sub-section in different middle or large sections, identical district codes may be assigned since the sub-section codes are classified by the functions of sub-sections. For example, even if a computer room and an office room in an office building belong to different middle sections, identical sub-section codes may be assigned to them because they have similar characteristics in terms of pest control. Thus, the pest control can be performed in a similar way. Further, even if sub-sections are of identical types different sub-section codes may be assigned to them by taking into account their middle sections, floor sections, and large sections. For example, although kitchens in a house and large-scale restaurant belong to an identical type of sub-sections, different sub-section codes may be assigned since the characteristics of the house and the large-scale restaurant are different. By using the sub-section code, one can easily find and understand the characteristics and functions of the sub-sections of a subject site and quickly establish an appropriate pest control measure, even when the pest control subject site has a complex structure.

In the embodiment of the present invention, a subject site is sectioned based on physical units of the building (such as floors and productions lines), but the criteria for sectioning in the present invention is not limited thereto. For example, a middle section of a subject site may be classified based on whether a wired or wireless communication system is suitable for the section. A department store, for example, has a first space including shops where there are many obstacles to a wireless communication, such as partitions for separating shops from each other, as well as a second space including a swimming pool and exercising machines where there is no obstacle for communication. Here, he middle sections for the first and second spaces are determined by the type of communication. Then, with reference to the determined middle sections, sensors for wired communication may be installed in the first space and sensors for wireless communication may be installed in the second space. The service technician can systematically install sensors required for each sub-section of the subject site based on the determined middle section of the site.

FIG. 20 shows a schematic block diagram of a remote control unit 750 in the remote monitoring system shown in FIG. 17.

As illustrated in FIG. 20, remote control unit cockroach traps 290, which are installed at predetermined positions of the subject site 710, 720, and 730, detect the movements of cockroaches and provide detected data corresponding to the movements. The cockroach traps 290 are connected to the remote control unit 750 through repeaters. The remote control unit 750 receives detection signal from the cockroach trap 290, processes the received data and transmits the processed signals through wired or wireless communication network. In other words, remote control unit 750 collects multiple detection signal transmitted from multiple cockroach traps 290 and appropriately processes the detection signals. It then transmits the processed signals to the central control unit in remote places. In FIG. 18, a solid line between the nth cockroach trap 290 and repeater 780 represents the wired communication and lightening symbols indicate the wireless communication.

Using Radio Frequency Identification (RF ID), repeaters can recognize multiple cockroach traps 290. In this case, the communication unit of the data processor of the cockroach trap 290 has the transponder of RF ID and the repeaters 780 have the reader of RF ID. The reader of the RF ID can recognize a large number of transponders even at long distances. Accordingly, by installing cockroach trap 290 anywhere in the subject site, the cockroach trap 290 is automatically recognized by the repeaters 780. In case numerous cockroach traps 290 are connected to numerous repeaters 780 and one repeater 780 has too many cockroach traps 290 connected thereto, then such repeater will become overloaded. Accordingly, an equal amount of cockroach traps 290 should be connected to each repeater. Specifically, a predetermined number of cockroach traps 290, which could be connected to one repeater 780, is decided beforehand and cockroach traps 290 beyond that number should be connected to other repeaters 780.

When the cockroach trap 290 is displaced or in cases of communication difficulties, the control unit of the data processor in the cockroach trap 290 saves the sensor identification data and counts the information for a period of time in a ring buffer. It then transmits the saved data to repeaters 780 when the connection with repeaters 780 is resumed. In a structure where multiple cockroach traps are connected, as explained earlier, the data processor is installed in only one or a small number of cockroach traps. Thus, the data processor saves the detection signal of other cockroach traps and transmits data to repeaters 780.

Real time transmission of detection signal from the cockroach trap 290 to the repeaters 780 or remote control unit 750 is most preferable. However, the transmission of detection signal could be delayed if too many cockroaches enter several different cockroach traps 290 at the same time, thus causing inaccuracy in understanding the increasing rate of the cockroach and preventing expeditious measures on the growth of cockroaches. In the embodiment of the present invention, each cockroach trap 290 is prioritized to solve the problems caused by the delayed transmission of data. For example, if the cockroach trap is installed in the restroom, the kitchen or the hall of a restaurant, then sanitation becomes the most important factor. Therefore, a priority is given to the kitchen, the hall and the restroom in that order. If the repeaters 780 conclude that the cockroach traps 290 in different places are sending the detection signal at the same time, then the repeaters receive the detection signal in the order of priority of the cockroach trap 290 rather than receiving the data in the transmitted order. In the above example, the detection signal from the cockroach trap 290 in the kitchen is received with first priority, followed by the detection signal from cockroach trap 290 in the hall, and then followed by the signal from the restroom. Although the detection signal from the cockroach trap 290 in the restroom may be little inaccurate, the kitchen can be kept with a high degree of sanitation.

The locations for installing the cockroach traps 290 and the number of cockroach traps 290 are determined by the ecology of cockroaches in the subject site, as well as by the environment and location of the specific building. Further, the location for installing cockroach trap 290 and the number of cockroach traps 290 may be determined based on the sub-section code assigned to the sub-sections of the pest control subject site.

According to the present invention, through sectioning the subject site, it becomes easy to manage the positions of cockroach traps 290 installed in each sub-section, as well as to analyze, utilize and maintain the pest-related information produced by the cockroach traps 290. Without sectioning, the service technician must identify the position of each cockroach trap 290 on a drawing of the subject site or show the positions in an absolute or relative coordinate system, which can be quite complex. In the remote monitoring system in accordance with one embodiment of the present invention, the positions of cockroach traps 290 installed in the subject site may be identified and used with ease and accuracy since the locations are stored in the central control unit 740 together with data on the sections. Precise location of the cockroach trap 290 can be identified through RF ID using GPS. The locations of cockroach traps 290 can be identified with GPS and such location data can be sent to the central control unit 740. The location data of cockroach trap 290 in the central control unit is sent to the service technician's portable communication terminals such as PDA. On the PDA of the service technician, the blueprint of the monitored subject site is displayed and saved in graphic file and the location of cockroach trap is marked. Thus, the service technician can easily find the location of cockroach trap 290. If cockroach traps 290 are not easily located, then the service technician cannot obtain accurate pest-related information. In addition, a captured cockroach may be kept for a long time in the cockroach trap so that it becomes a new habitat for the cockroaches.

In addition, in one embodiment of the present invention, due to the sectioning, the locations and the number of cockroach traps 290 installed in each sub-section, as well as the pest-related information, may be managed in relation to the sectioning information. Thus, the pest-related information can be managed and analyzed per sub-section. Therefore, useful information that is effective for pest control in each sub-section can be derived from the pest-related information.

The cockroach trap 290 provides the detected data by detecting cockroach with the sensor and the data processor. The detected data are transmitted to remote control unit 750 together with identification signal unique to each cockroach trap 290, each sensor, time-stamp and cockroach count information through wired or wireless communication. As explained above, several cockroach traps are grouped and one of the multiple cockroach traps in the group has the data processor, which can transmit data to remote control unit 750. In addition, even if there are several traps 290 with data processor 270, each data processor can be connected in a master-slave manner. In this case, data processed by the data processors, which function as slaves under a master, is transmitted to remote control unit 750 through the master.

The detected data may be transmitted from cockroach trap 290 to remote control unit 750 through repeaters 780. Especially, the repeaters are necessary if the monitored subject sites 710, 720 and 730 occupy a wide area or have a complex structure. The appropriate number of repeaters 780 is determined based on the dimension of the monitored subject sites 710, 720 and 730 and the number of the cockroach traps 290, etc. Generally, installation of the system is easy if transmission of data is done through wireless communication among cockroach traps 290, repeaters 780 and remote control units 750. However, depending on the structure and the internal configuration of the monitored subjects sites 710, 720 and 730 and the arrangements of the furniture and facility units, it may be preferable to install communication lines between repeaters 780 and nth cockroach trap 290 for cost reasons.

The remote control unit 750 stores and processes the detected data received from cockroach trap 290 and transmits them to central control unit 740. The remote control unit 750 is installed at selected positions of each building 710, 720 and 730 and the location of installation is decided by considering the type of communication (i.e., wireless or wired communication), the type and condition of each monitored subject sites 710, 720 and 730 and the distribution of cockroach traps 290. This is so that secure communications are guaranteed and the units are not subject to mechanical damage or breakdown.

As illustrated in FIG. 20, the remote control unit 750 includes functional modules such as a detected data processing module 1006, a receiving module 1008, a transmitting module 1009, a transmission time determining module 1011, a memory 1012 and a data input module 1014. Functions of the modules will be briefly explained below.

The receiving module 1008 receives the detected data from cockroach trap 290 or repeaters 780 and transfers them to detected data processing module 1006. The detected data processing module 1006 processes the detected data and collects pest-related information. The pest-related information includes, for example, types and population of invaded or captured pest, invasion time, invasion path, and invasion position. Various data can be generated depending on the types and arrangement of cockroach traps 290. The processed pest-related information is sent to transmitting module 1009 and transmitting module 1009 transmits the processed pest-related information to the central control unit 740. The transmission time determining module 1011 determines whether to transmit the pest-related information to central control unit 740 periodically or in real time. The memory 1012 is used to store the pest-related information of the subject site. The data input module 1014 is provided for the service technician to manually input other pest-related information that is not detected by cockroach traps 290. Also, it may be used to revise the errors in the data of the cockroach trap 290.

Hereinafter, the detailed explanations of the remote control unit will be provided below.

The detected data processing module 1006 of the remote control unit 750 processes detected data transmitted from respective cockroach trap 290.1, 290.2 and 290.n based on the identification data of sensors and the time-stamp information that are transmitted together. The detected data processing module 1006 determines that a specific cockroach trap 290 has failed and generates sensor failure signals indicating an abnormal status of the cockroach trap 290 if detected data has not been received for a long time from the trap or the data over a predetermined range is received. The detected data processing module 1006 of the remote control unit 750 transforms the pest-related information into a format suitable for transmission to the central control unit 740. Also, the display such as LED can be installed in a cockroach trap 290, which can indicate the status of the sensor and the data processor. Thus, it can indicate whether or not the cockroach trap is broken by receiving failure signals from the detected data processing module 1006. The service technician does not have to disassemble a cockroach trap 290 to find out whether the cockroach trap 290 is broken. Such task can be done through confirming it on the display.

The transmitting module 1009 of the remote control unit 750 transmits the pest-related information or the failure signals to the central control unit 740 through wireless network 760 or wired network 770.

The transmission time determining module 1011 of the remote control unit 750 determines whether data transmission from the remote control unit 750 to the central control unit 740 should be done periodically (for example, on a certain time in the middle of the night) or on a real time basis. The types of pest monitored, as well as the types and conditions of the communication network and/or power supply used by the remote control unit 750, should be considered in deciding whether to transmit data periodically or in real time. In case of using public switched telephone network for wired communication 400, the data may be transmitted to central control unit 740 at night to minimize the interruption of daytime calls. Nevertheless, transmission time determining module 1011 of the remote control unit 750 may be set to transmit data immediately when cockroaches appear in abnormal frequency. If the pest-related information is transmitted periodically, the data is stored in the memory 1012 for a predetermined period. The pest-related information may be classified by time period (e.g., period between 0 and 8 hours, 8 and 16 hours, and 16 and 24 hours) to be separately stored in memory 1012.

The data input module 1014 of the remote control unit 750 may be used by the service technician or a user of the monitored subject site to input other pest-related information that are not easily collected through the cockroach trap 290. For example, when pest control is performed based only on the pest-related information collected through cockroach traps 290, the data from places without cockroach traps 290 cannot be obtained. In addition, the reliability of the information could be affected by incorrect data that has accumulated due to minor operation failures. The data input module 1014 solves the above problem by allowing a service technician or a user of the monitored subject site to input supplementary information. The supplementary information, such as the data collected from cockroach traps 290, is transmitted to the central control unit 740 through the transmitting module 1009.

The above-described function modules 1006, 1008, 1009, 1012 and 1014 of the remote control unit 750 may be implemented with hardware specifically designed to perform the above-explained functions, or software modules programmed to perform the functions in general hardware.

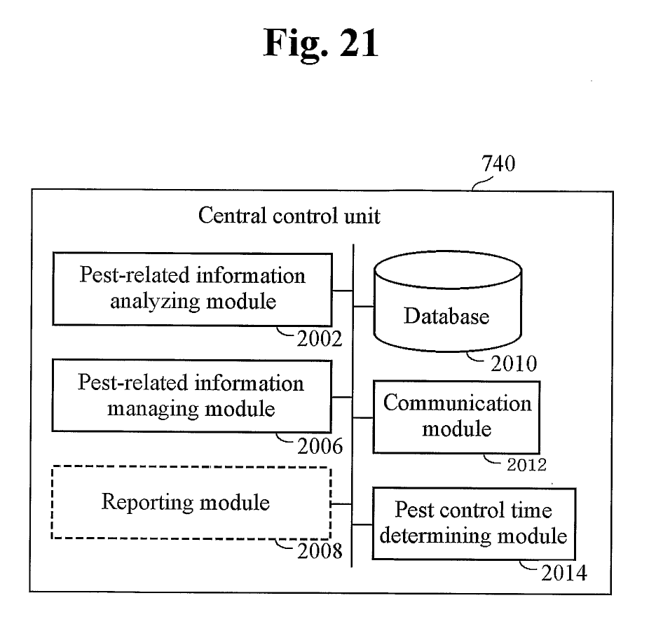

FIG. 21 is a block diagram conceptually showing the configuration of central control unit, which is included in the remote monitoring system of FIG. 17.

As illustrated therein, the central control unit 200 comprises pest-related information analyzing module 2002, pest-related information managing module 2006, a database 2010, communication module 2012, and pest control time determining module 2014. The pest-related information analyzing module 2002 receives the pest-related information transmitted periodically or in real time from remote control unit 750 and analyzes it. The pest-related information managing module 2006 stores, updates and manages the pest-related information in database 2010. The communication module 2012 performs wired/wireless communications. The pest control time determining module 2014 determines the time when pest control needs to be performed. The central control unit 740 may further comprise report-preparing module 2008 for preparing a report periodically or as needed with regard to the pest-related information (the report preparing module 2008 is depicted with a dotted line in FIG. 21 and is an optional component).

The pest-related information analyzing module 2002 receives the pest-related information through the communication module 2012 and analyzes the data according to various categories. More specifically, pest-related information analyzing module 2002 analyzes the pest-related information to obtain data (e.g., frequency of occurrence or invasion, the number of appearance and invasion of cockroaches, etc.) by various categories (e.g., building, locations at which cockroach traps 290 are installed in each sub-section of a sectioned site, date and time, types of pest and sub-section codes) or various other criteria used for performing pest control.

For instance, the pest-related information classified by the sub-section code can be used to prepare a pest control measure with respect to a monitored subject site as follows. If monitored subject sites were a plurality of large-scale supermarkets each having similar structure, then such supermarkets would be comprised of similar sub-sections. In this case, an appropriate pest control measure may be obtained by comparing, among the large-scale supermarkets, the pest-related information of sub-sections having identical sub-sections code. For example, a service technician utilizes a relative value of pest appearance frequency for a particular sub-section code, as well as an absolute value of pest appearance frequency in each large-scale supermarket, to establish a pest control measure. For example, in case where the pest-related information of store sub-sections in two large-scale supermarkets A and B are similar but pests appear more frequently in a warehouse sub-section of supermarket A than in that of supermarket B, the service technician determines that a cockroach generating factor exists in the warehouse of large-scale supermarket A rather than that of supermarket B so that an additional pest control measure is required for large-scale supermarket A.

Meanwhile, in one embodiment of the present invention, the pest-related information analyzing module 2002 decides the grade for each cockroach trap 290 (preferably in real time) based on the number of cockroaches detected by each cockroach traps 290. For example, pest-related information analyzing module 2002 decides the grade of each cockroach trap 290 as grade L1 when the number of detected cockroach is one to three, grade L2 when the number of detected cockroach is four to ten, and grade L3 when the number of detected cockroach is eleven to twenty. As the detected populations of cockroach increase, the grade of the cockroach trap 290 also gets higher and after the pest control operation is performed, the grade of the cockroach trap 290 is reset. Thus, the grade of each cockroach trap 290 is useful for monitoring a status of pest appearance and determining whether or not an emergency pest control measure is required (detailed description will follow). In addition, the analyzed data from the pest-related information analyzing module 2002 may contain data such as previous history of cockroach appearance of each sub-section. With reference to historical data of cockroach, the service technician determines whether or not a new cockroach invasion path has appeared, and whether or not pest control chemicals are effective. Preferably, the categories used for analyzing the pest-related information are easily added or deleted, as needed.

The pest-related information managing module 2006 stores the pest-related information transmitted regularly or in real time from the remote control unit 750 in the database 2010. More specifically, the pest-related information managing module 2006 receives the pest-related information, which is new1y transmitted from the remote control unit 750, and adds to or updates the existing data. Preferably, various analysis categories used by the pest-related information analyzing module 2002 are stored and managed in the database 2010.

The pest control time determining module 2014 determines whether the pest control is needed immediately based on the analyzed data of the pest-related information analyzing module 2002. The pest control time determining module 2014 notifies the service technician by alarm if the analyzed results of the pest-related information analyzing module 2002 are determined to be an emergency.

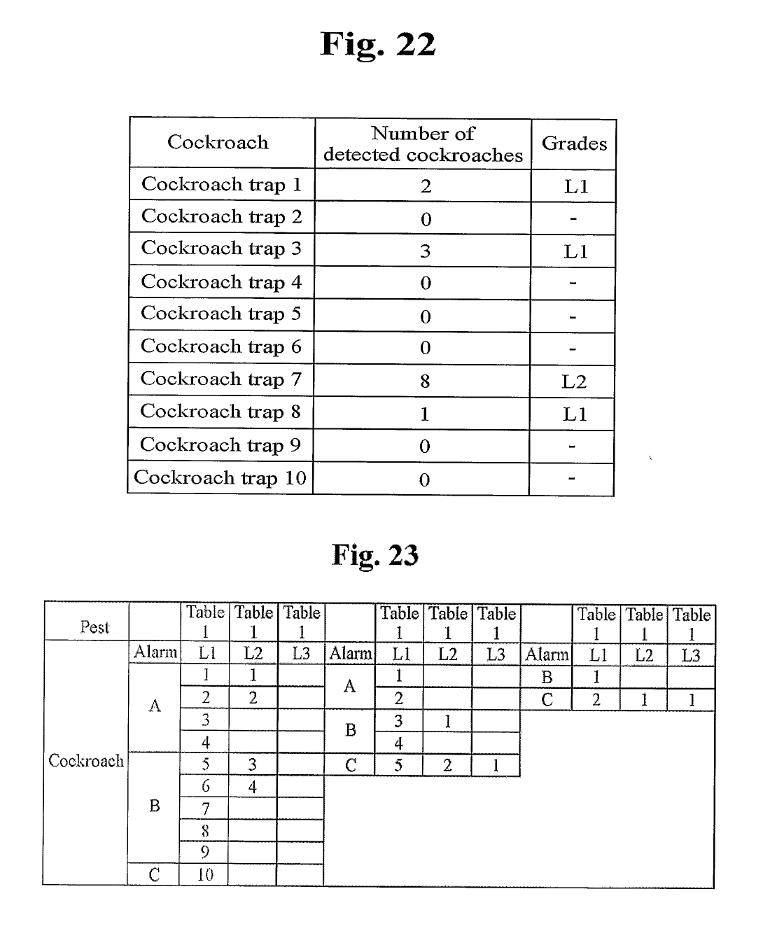

Referring to FIG. 22 through 24, a specific example of how the pest control time determining module 2014 utilizes the analyzed results (hereinafter, “analysis result”) from the pest-related information analyzing module 2002 will be explained below.

FIG. 22 is a table showing the analysis results of cockroaches' activities in a sub-section.

Referring to the table in FIG. 22, the number of detected cockroaches from each cockroach trap 290 and grades assigned to each cockroach trap 290 are shown as analysis results for each of the ten cockroach traps 290 installed in a sub-section. As seen from the table, the selected sub-section contains three L1-graded sensors (one to three cockroaches detected) and one L2-graded sensor (four to ten cockroaches detected). The analysis per each type of pest in each district is provided by pest-related information analyzing module 2002, preferably in real time.

Pest control time determining module 2014 determines the pest control time using the analysis results as follows:

FIG. 23 illustrates an example of a table used by the pest control time determining module 2013 for determining the time for pest control (“alarm table”);

FIG. 23 is a table, which illustrates how the alarm type (i.e., alarms A, B or C) is determined according to the number of cockroach traps of grade L1 and L2. The alarm type represents the seriousness of cockroach appearance in the each sub-section. In the embodiment of the invention, alarm A indicates that the service technician has to carefully perform periodic pest control operation, while alarms B and C indicate that the service technician must perform pest control operation immediately. Alternatively, the service technician may perform the pest control operation immediately in case alarm C occurs or in case alarm B occurs over a predetermined number of times within a certain period.

The type of alarm is determined by considering the type of sub-section where cockroaches appear, while alarm table may be changed depending on the characteristics of sub-section. The three tables shown in FIG. 23 are prepared to apply three different standards according to the type of sub-section. Table 1 of the alarm table in FIG. 23, for example, represents that alarm B applies if five to nine cockroach traps graded LI are in the sub-section and alarm C applies if more than ten LI or five L2 cockroach traps are in the sub-section.

In case there is one L1 grade cockroach trap, alarm A applies according to table 1 of FIG. 23, whereas alarm B applies in table 3. Table 1 of FIG. 23 is applicable to the restroom or kitchen where the cockroach is likely to appear at various times. Table 3 is applicable to the sub-sections, such as guestrooms of a hotel or a hospital ward, where appearance of cockroach causes serious consequences.

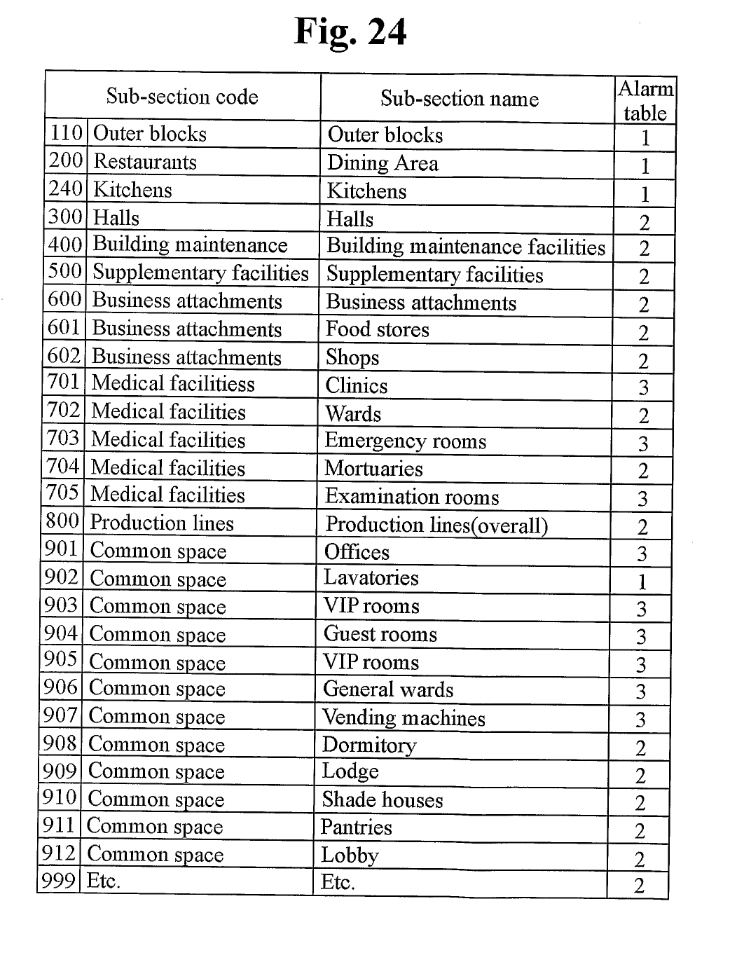

FIG. 24 is an application table for deciding which alarm table to apply according to the sub-section code (i.e., characteristics of the sub-section). The application table may be updated by considering the status of the monitored subject site to see whether it is subject to intensive monitoring, unique characteristics of sub-section, etc.

Hereinafter, an example of analysis conducted by the pest-related information analyzing module 2002 based on the location and rate of cockroach invasion, etc., will be explained in detail. For purposes of illustration, a monitored subject is limited to guestroom No. 1003 and an accompanying restroom on the 10^{th} floor of hotel A. In this case, the hotel A is a large section, the 10^{th} floor is a floor section, Room No. 1003 is a middle section, and the guest room and the restroom belong to a sub-section.

When fourteen cockroaches appear in the guestroom No. 1003, four out of ten cockroach traps 290, which are installed at hotel A/10^{th} floor/Room 1003/guestroom, detect the cockroaches and the pest-related information is transmitted to the central control unit. After that, the pest-related information is analyzed by the pest-related information analyzing module 2002 according to the locations where the cockroaches appear and such analysis (shown in FIG. 22) is obtained for each cockroach trap 290. In this case, the pest-related information analyzing module 2002 gives grade L1 to trap-1, trap-3 and trap-8, which detected 1 to 3 cockroaches, and further gives grade L2 to trap-7 that detected 4 to 10 cockroaches. With reference to the application table shown in FIG. 24, table 3 of FIG. 23 is applied to guestroom No. 1003. Since the number of traps having grade L2 is 1, alarm C is notified, in which the service technician then performs an immediate pest control.

If the analysis result of FIG. 22 is for a case in which the cockroaches appear in the restroom (and not in the guest room), then table 1 is applied (refer to the application table of FIG. 23) such that alarm A is notified unlike the case of the guest room. Alarm A represents that, instead of immediate pest control, the service technician can perform careful periodic pest control operation.

However, if the pests appear frequently in the restroom (even in small numbers), an immediate pest control is required even in the restroom. In this case, the pest control time determining module 2014 utilizes the analysis result classified by an appearance frequency. For example, the pest control time determining module 2014 may be set to notify alarm B if the number of L1-graded traps is over three in a week. Therefore, in addition to the alarm table of FIG. 23, the pest-related information may be applied to various other tables to prepare for pest activity.

Next, the communication module 2012 in the central control unit 740 performs wired/wireless communication with communication module 1008 of remote monitoring apparatus 100. Since the technologies for the wired/wireless communications are well known, a description thereof will be omitted herein.

Referring to the FIGS. 23A and 23B, the reporting module 2008, which is optionally included in the central control unit 740, will be explained in detail. FIGS. 23A and 23B illustrate an embodiment of the report prepared by the reporting module 2008 in the central control unit 740.

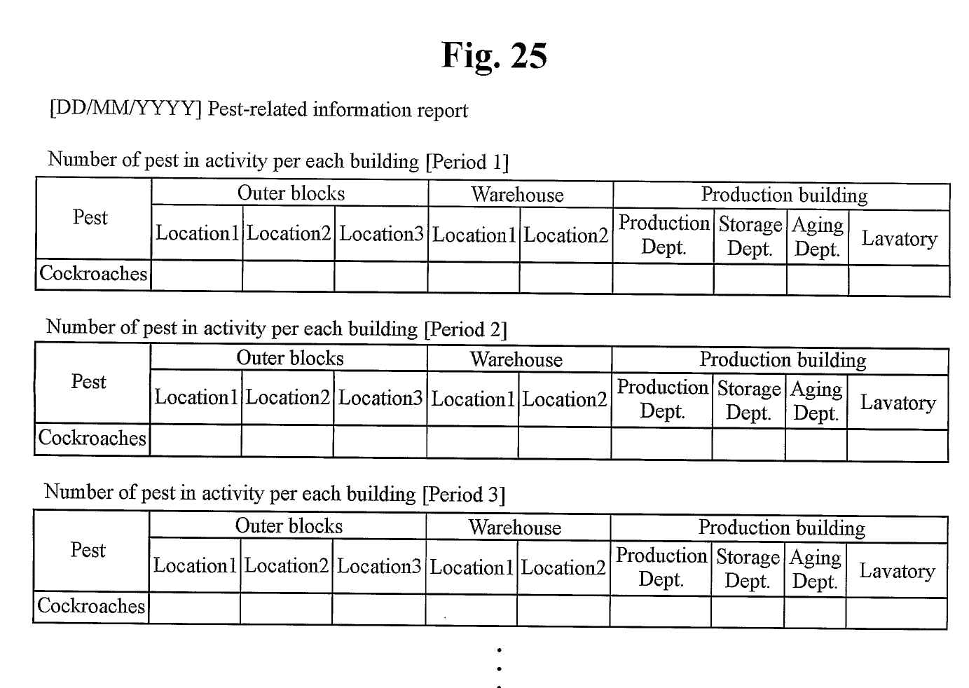

As illustrated in FIG. 25, the reporting module 2008 prepares a pest control report at a predetermined time of the day based on the analysis result of the pest-related information analyzing module 2002. The pest report may contain the population (number) of detected pest per time period (i.e., Period 1, Period 2, Period 3, etc.) and the building 710, 720 and 730, etc. The preparation of pest control report is facilitated by classifying the pest related information by periods and buildings, and also by storing the pest-related information in remote control unit 750 or central control unit 740. The active number of cockroaches in each building 710, 720 and 730 is once again classified by the installed location of cockroach trap 290 and the number of captured cockroach detected by the trap is classified by the type and then recorded.

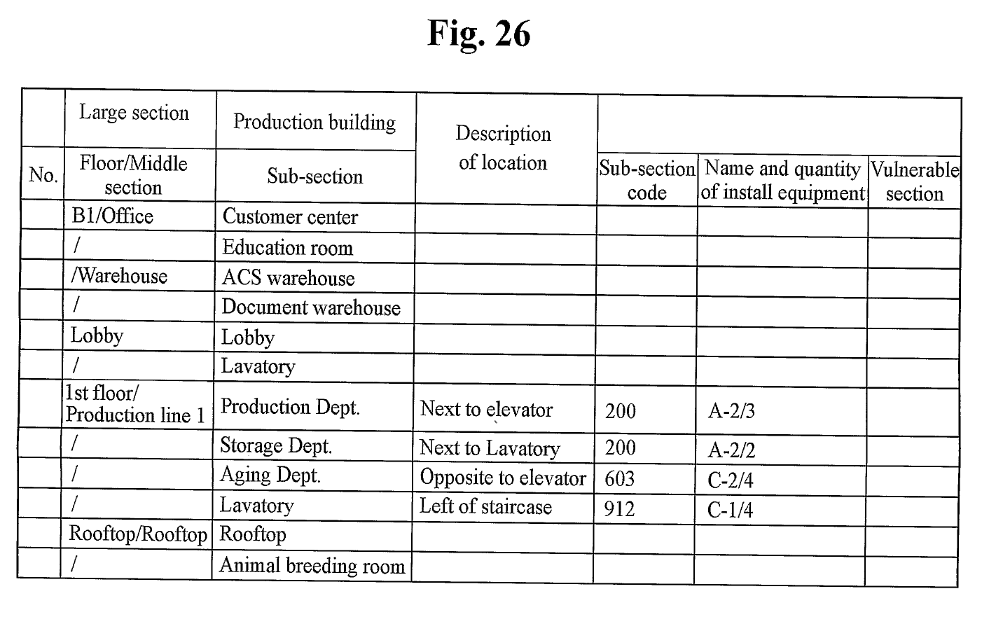

FIG. 26 illustrates an embodiment of a report containing information with respect to sub-sections of the monitored subject site (hereinafter, “sub-section report”). It is a report regarding the production building shown in FIG. 19 where four-tier sectioning is used.

The sub-section report is pre-stored in the central control unit 740 so that the service technician may easily perform pest control operation for each sub-section of the monitored subject. After completing the pest control operation, the sub-section report may be updated. The sub-section report shown in FIG. 26 contains data fields such as the name of the sub-section, the description of location, the sub-section code, the name and quantity of installed equipment and whether the sub-section is vulnerable. Large, floor, middle and sub-sections are shown in the second and third rows of the sub-section report and a brief description for the location of each district is provided on the description of the location column. (The location data enables the service technician to easily find each sub-section). The sub-section codes corresponding to the sub-sections are provided in the sub-section code field. In this embodiment, an identical sub-section code is assigned to a production department and a storage department. Therefore, identical equipments are provided to both departments. The name and quantity of equipment installed in each sub-section are provided in the equipment/quantity field. The vulnerable section field is marked in case that the frequency of cockroach appearance is higher than the predetermined level, or a district is vulnerable to cockroach due to other reasons. By examining this district report, the service technician can easily understand the structure of the monitored subject. Further, the service technician can easily understand the status of the pest by using the sub-section report together with the pest-related information. Therefore, by using this type of report, the service technician easily obtains the necessary information without relying upon individual memory or experience. Accordingly, even if the service technician for a specific monitored subject site is changed, pest control may be effectively performed. Further, pest control is effectively performed even if a person not assigned to a specific site is sent to the site, as long as the person has basic skills in pest control. The report in this specification includes a report in hardcopy format, as well as a screen-display, an electronic file and an e-mail format.

By using these reports, the pest-related information, which is obtained from the cockroach trap 290 installed in each sub-section, is systemically transmitted to the service technician. The service technician then examines the pest-related information of each sub-section to perform pest control operation.

Preferably, the reports are prepared using the analysis result of pest-related information analyzing module 2002. Such reports can be made periodically or as needed. Also, the reports are stored for a certain period of time and are statistically re-analyzed according to predetermined categories. More specifically, by storing and examining short-term reports accumulated over a long time (e.g., a month, a season or a year) to observe changes over time, one can obtain the secondary data. For example, if pest-related information in a pest control monitored subject site shows having a similar trend for a long time and indicates a slight increase in pest appearance over a long period of time, then we can guess that a factor relating to cockroach appearance exists in the site and has not been treated. Further, by examining the reports over a long time, the effects of change of structure of the monitored subject site or change of chemical for pest control on the pest activity may be observed. The pest-related information, which is analyzed over a short term, can be sampled or averaged by a week or a month so as to be used in deciding a long term trend.

By analyzing the pest-related information according to predetermined categories, one may obtain data such as where to install chemicals for pest control and the amount of necessary chemicals. Such information can also be included in the report. In this case, the service technician can simply place the chemicals in the monitored subject site based on the report. This is so that the burden of checking the location or the amount of chemicals may be reduced. The locations and amount of the chemicals may be determined based on the pest-related information (or secondary data derived from the pest-related information) from cockroach traps 290 by using a simple algebraic formula or by referencing a look-up table.

Further, in accordance with one embodiment of the present invention, the reports may contain activity information of cockroach, which is to be exterminated, at a position where a chemical is used (before and after installing the chemicals for exterminating the cockroach). The reports may be in the form of a graph where one can easily understand the trend. The reports are used to observe the effects of a chemical on a pest. In case there is no effect, the reports are used to determine whether the pests in the corresponding area have developed any tolerance to the chemicals used.

By using the sub-section report, the positions of cockroach trap 290 and the pest control equipment installed in each district can be effectively managed. In the sub-section report, the type and quantity of the pest control equipment installed in each sub-section are represented. During pest control, the service technician takes proper measures to check as many equipment in each sub-section as identified in the sub-section report, as well as to eliminate the captured pests and to check the functions of the equipment.

Referring to FIGS. 24 and 25, the operation of the remote monitoring system for pest control, which is in accordance with the embodiment of the present invention, will be explained below in detail.

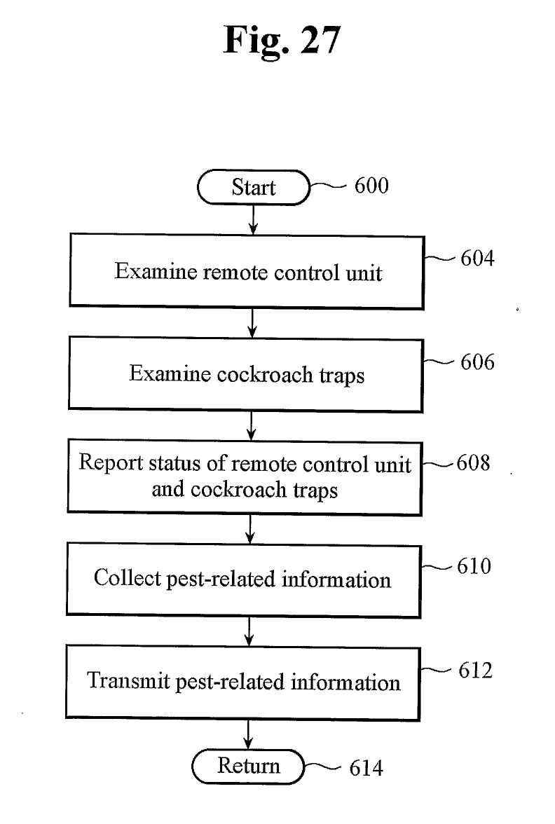

First, the major operation of the remote control unit 750 will be explained in view of FIG. 27. FIG. 27 is a flow chart conceptually showing the major operations of the central control unit 750 in the remote monitoring system for pest control (shown in FIG. 17).

As illustrated therein, electrical power is applied in order to start the operation (step 600) and the components, such as remote control unit 750 and cockroach traps 290, are examined (steps 604 and 606). As a result, the status of the remote control unit 750 and the cockroach traps 290 are transmitted and reported to the central control unit 740 (step 608). Through such step of status reporting, the central control unit 740 becomes ready to communicate with the remote control unit 750. Preferably, step 608 is regularly performed to periodically check the status of the remote control unit 750 by the central control unit 740, as well as when the electrical power is applied.

Then, the remote control unit 750 receives the detected data from each cockroach trap 290 to collect the pest-related information (step 610). It then transmits the collected pest-related information to the central control unit 740 (step 612).

The control process of the above remote control unit 750 returns to an appropriate step among the previously explained. The above-mentioned steps do not have to be performed sequentially. Also, from power-on to power-off, all the steps do not have to be repeated the same number of times.

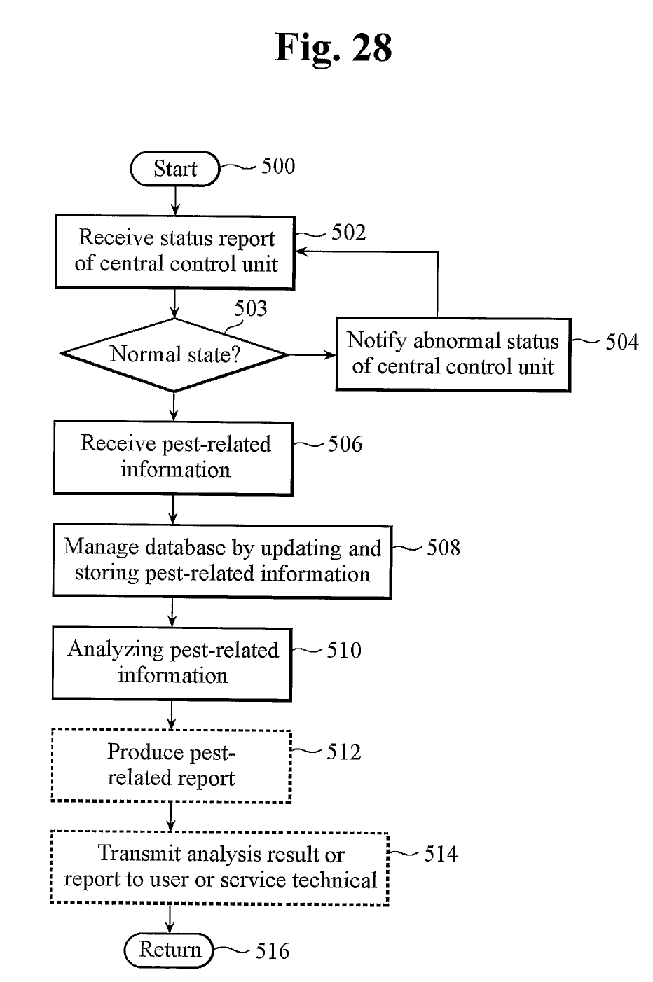

The major operations of the central control unit 740 will now be explained in view of FIG. 28. FIG. 28 is a flow chart conceptually showing the major movement of the remote monitoring system for pest control (shown in FIG. 17).

As illustrated therein, electrical power is applied in order to start the operation in step 500. The central control unit 740 receives a status report from the remote control unit 750, which represents whether or not the remote control unit 750 and cockroach trap 290 are in a normal state (step 502). If it is confirmed that the components of the remote control unit 750 are in the normal state, then next steps are performed. However,if the conditions of the cockroach trap 290 of the remote control unit 750 or the remote control unit 750 are determined to be abnormal, then such information is notified to the service technician (step 204). The service technician, for instance, should immediately repair the apparatus if the cockroach trap 290 in important sections, such as a hotel or a guestroom, is out of order. The failed cockroach traps 290 in sections, such as restrooms, can be repaired during regular check-ups. To obtain reliable response, the remote control unit 750 may report the failure of cockroach traps 290 to the service technician after receiving a failure response of the traps (e.g., three times).

Next, the central control unit 740 receives the pest-related information transmitted from the remote control unit 750 (step 506). To receive the pest-related information reliably, the communication module 2012 has to be examined first. Such a step is well known to a person of ordinary skill in the art. Therefore, the detailed descriptions will be omitted herein.

After the above, the central control unit 740 performs database management operation by comparing the received pest-related information with the pre-stored data in the database 2010. It then updates or stores the new data as needed (step 508).

Subsequently, the central control unit 740 analyzes the pest-related information stored or updated in the database 2010 based on predetermined categories for analysis (step 510). Preferably, analysis of the pest-related information is performed to find information such as the frequency of appearance or invasion, as well as the number of appearing or invading cockroaches based on various categories (e.g., each building where remote monitoring apparatus 100 are installed, the positions of cockroach trap 290 in each building or specific times of the day.

Optionally, the central control unit 200 may produce a report containing the analysis result of the pest-related information (step 512). The details of the report will be omitted herein since it has already been explained in view of FIGS. 23A and 23B. The central control unit 200 transmits the analysis result or the report to a user or a service technician of each site 710, 720 and 730 (step 514). Step 514 is also an optional step.

After the above, control process of the central control unit 740 is returned to an appropriate step among the previously explained steps.

The above steps do not need to be performed sequentially or repeated the same number of times from power-on to power-off.

The following describes a remote monitoring system of another embodiment of the present invention.

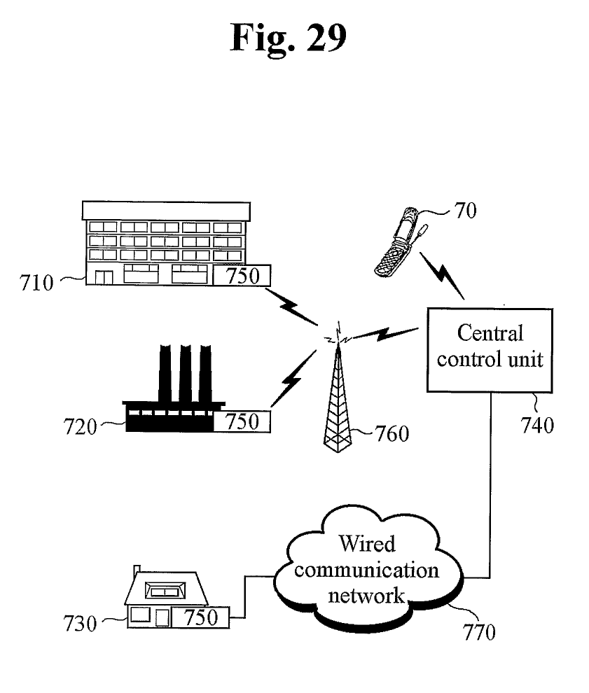

FIG. 29 is a diagram chart conceptually showing the remote monitoring system for pest control according to the second embodiment.

The difference between the first and second embodiments of the remote monitoring system of the present invention is that the central control unit 740 re-transmits the analysis result of the pest-related information to users of each building 710, 720 and 730 and/or to the service technician. More specifically, the service technician receives the analysis result of the pest-related information by using mobile communication terminal 70, such as a personal digital assistant (PDA) or a mobile phone, and performs pest control operation that is suitable for each monitored subject site.

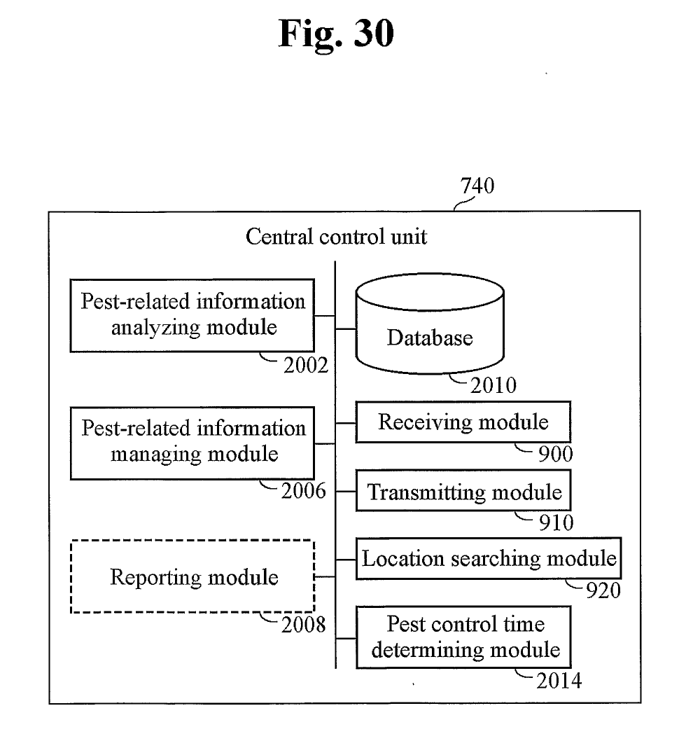

FIG. 30 is a block diagram showing the central control unit 740 according to the second embodiment of the present invention.

The second embodiment comprises a receiving module 900 and a transmitting module 910 instead of the communication module of the first embodiment. Also, the central control unit 740 may optionally include a location searching module 920.

In the second embodiment, the receiving module 900 receives pest-related information from the remote control unit 750 and transmits the data to pest-related information analyzing module 2002. An analysis result is transmitted from pest-related information analyzing module 2002 to mobile communication terminal 70 of the service technician through transmitting module 910 of central control unit 740. The pest-related information is transmitted to the service technician periodically, or in response to the service technician's demand, or according to other predetermined transmission protocols. For example, in case the service technician is scheduled to visit a subject site, the pest-related information of the subject sites to be visited on a particular day is transmitted to mobile communication terminal 70 of the service technician on the basis of the visiting schedule. In this embodiment, in cases of an emergency situation in a subject site, central control unit 740 searches the locations of service technicians possessing mobile communication terminal 70 through the location searching module 920 and transmits pest-related information to the service technician located nearest to that building where emergency happened. The location searching module 920 may receive location information of mobile communication terminal 70 (whenever necessary) through communication providers.

In addition, by using mobile communication terminal 70 and location searching module 920, the paths or movements of service technicians may be effectively managed. For example, since central control unit 740 detects the location of each service technician through mobile communication terminal 70, the order of visits for pest control may be effectively determined. If the workflow of pest control is determined so that the technician can first take care of the closest site, the time required to travel to the sites can be reduced, thus increasing the efficiency of pest control operation.

In accordance with the second embodiment of the present invention, the length of time from when the emergency occurs to when the pest control is performed may be shortened. Generally, central control unit 740 is connected to a plurality of remote monitoring apparatuses 100 through wired or wireless communications. Thus, some remote monitoring apparatuses 100 may be located somewhat far from the central control unit 740. If the service technician at the central control center receives an analysis of pest-related information from central control unit 740 and then goes to a remote pest control subject site, it requires much time. According to the second embodiment of the present invention, the analysis result is automatically transmitted to a service technician nearest to the site where many cockroaches appeared (meaning emergency). This is so that the service technician can immediately exterminate the cockroaches. Since the service technician can check other pest-related information on the way to the subject site, he/she may perform a regular examination and other pest control operation when exterminating the cockroaches.

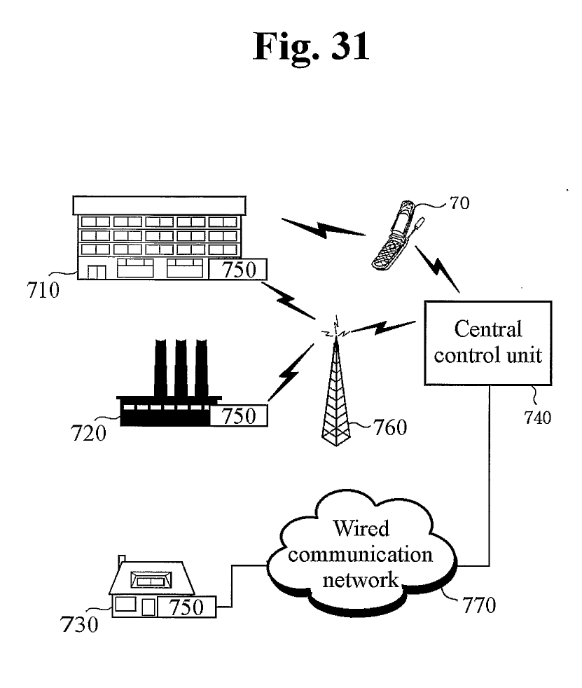

FIG. 31 is a block diagram conceptually showing the third embodiment of the remote monitoring system.

The difference between the second and third embodiments of the present invention is that pest-related information may be directly transmitted from remote control unit 750 to mobile communication terminal 70 in the third embodiment. Although mobile communication terminal 70 shown in FIG. 31 communicates with remote control unit 750 by wireless communication, mobile communication terminal 70 can also be configured to communicate with the remote control unit 750 via both wired and wireless communications. In the third embodiment of the present invention, the service technician may receive an instruction to move to a subject site from the remote control unit 750, which is installed at the site, or from the central control unit 740. He/she can also receive pest-related information from both.

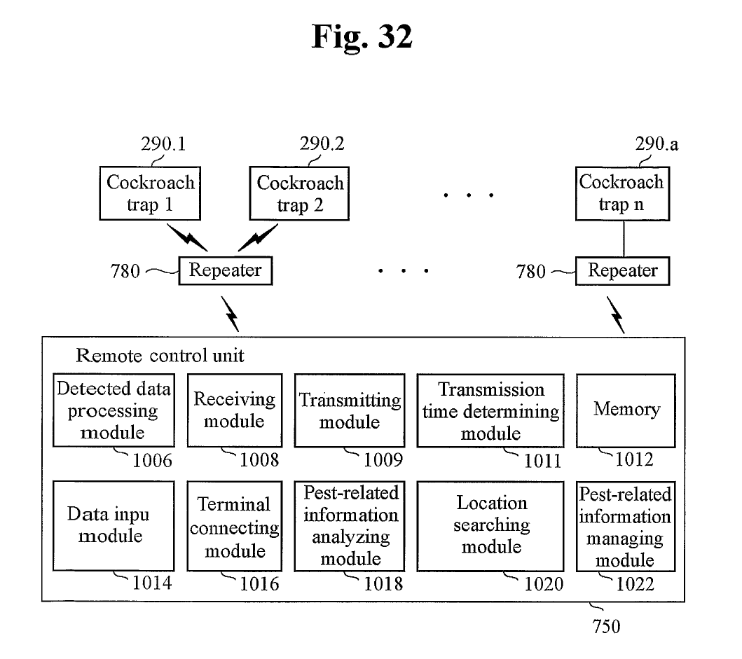

FIG. 32 is a block diagram conceptually showing the remote control unit 750 according to the third embodiment.

Compared to the first embodiment, the remote control unit 750 of the third embodiment further includes a pest-related information analyzing module 1018, a pest-related information managing module 1022, and a terminal connecting module 1016. Also, a location searching module 1020 may be optionally added to remote control unit 750.

The location searching module 1020 installed in the remote control unit 750 searches the location of the mobile communication terminal 70. The detailed analysis of information is performed in pest-related information analyzing module 1018 in remote monitoring apparatus 100. The procedure for analyzing information in the pest-related information analyzing module 1018 is identical to that of the central control unit 740. An analysis is stored in memory 1012 by the pest-related information managing module 1022. A service technician receives an instruction to go to a subject site through mobile communication terminal 70. At the site, the service technician then connects the mobile communication terminal 70 to the terminal connecting module 1016 of the remote control unit 750 by wired/wireless communication. When the mobile communication terminal 70 is connected to the terminal connecting module 1016, the terminal connecting module 1016 retrieves the analysis result of the pest-related information stored in the memory 1012 and transmits the same to the mobile communication terminal 70. The service technician performs pest control on the basis of the analysis result received through mobile communication terminal 70. In accordance with the third embodiment of the present invention, the remote control unit 750 may comprise a reporting module (not shown) so as to transmit a report, which is produced by the reporting module, to the mobile communication terminal 70 through the terminal connecting module 1016. For example, after checking the report, which includes the information on sections of a site through the display of mobile communication terminal 70, the service technician performs pest control suitable for the structure of the site.

In the third embodiment of the present invention, most of the data is directly transmitted from the remote control unit 750 to the mobile communication terminal 70 without using a commercial wireless communication service. As a result, the costs for wireless communication may be reduced.

Similar to the second embodiment, the location searching module 1020 may be employed in the third embodiment of the present invention for searching the location of a service technician nearest to the subject site. Further, when an emergency occurs, an instruction to move to a subject site is directly transmitted from the remote control unit 750 to the mobile communication terminal 70 of a service technician, who is closest to the subject site.

The procedures of pest control will be explained by using the above-explained remote monitoring system of the present invention.

When alarm C is issued for a monitored subject site in the central control center, the service technician refers to the report in order to understand the environment of the building that is in need of pest control. The service technician sends the departure signal to the remote control unit by using a PDA before going to the monitored subject site. When arriving at the subject site, he/she connects the PDA to the terminal connecting module of the remote control unit to receive the pest-related information regarding any changes in the circumstances. The arriving time at the monitored subject site is transmitted to the remote control unit and the central control unit. The service technician performs the work by conversing with the user of the monitored subject about the problems and receives additional demands from the user, which are transmitted to the central control unit through PDA. The service technician performs the cockroach trap check-up, the replacement of birdlime, the chemical treatment, etc. After everything is done, the cockroach trap is reset so that the counted population of the cockroaches is set to zero. When everything is done, he/she connects his/her PDA to the terminal connecting module of the remote control unit in order to confirm the situation. The day's work is done when the service technician explains the situation to the user of the building using the PDA. The service technician, who is done with the pest control, moves to another monitored subject site according to the instructions from the central control center. In order to move quickly to the subject site, a relatively short route to the monitored subject should be selected by using the data received by the PDA from the center.

Although the analysis of the pest-related information is performed in remote control unit 750 in the embodiment explained above, the mobile communication terminal 70 can be configured to analyze the pest-related information by adding a program or separating hardware to mobile communication terminal 70. That is, the mobile communication terminal 70 may comprise a pest-related information analyzing module. The procedure to be performed in the mobile communication terminal 70 is similar to that of the central control unit 200.

According to the second and third embodiments of the present invention, a service technician, who is closest to a monitored subject site, may perform pest control. Conventionally, each service technician is assigned to a corresponding monitored subject site so that only the assigned service technician performs a pest control in the corresponding monitored subject site. As a result, if the service technician for a specific monitored subject site is switched or replaced, effective pest control on that site becomes difficult since a new service technician has no systematic data on the subject site. However, in the second and third embodiments of the present invention, service technicians obtain analyzed pest-related information on a monitored subject site from the central control unit 200 or remote monitoring apparatus 100 while moving to the subject site. This is so that any service technicians may effectively perform pest control.

### INDUSTRIAL APPLICABILITY

As described above, according to the present invention, the capture rate of the cockroach will become higher. Thus, it is possible to obtain an accurate analysis on cockroach appearance, which would enable the pest control at the appropriate time.

Second, many cockroaches are attracted to the trap. Thus, captured cockroaches in the trap can be counted as constituting all or majority of the cockroaches in the monitoring section, thereby enabling more accurate statistical analysis.

Third, with the sensor provided in the cockroach trap, the service technician can be aware of cockroach appearance in remote places without the need to visit the site of installation. Thus, work efficiency is increased since the service technicians only need to visit the site when there is a cockroach invasion.

While the present invention has been shown and described with respect to the particular embodiments, those skilled in the art will recognize that many changes and modifications may be made without departing from the scope of the invention as defined in the appended claims. For example, the cockroach trap according to the embodiment of the invention not only can be used for capturing and monitoring the activities of the cockroaches but also can be used for other small vermin such as ants.

1. A cockroach trap, comprising:
a plate;
a first birdlime adhered to at least a portion of the plate;
a slant having an inclined plane and a vertical section, the slant being disposed on the plate and adjacent to at least a part of the first birdlime; and
a second birdlime adhered onto the vertical section.

2. The cockroach trap of claim 1, comprising at least one slant surrounding the first birdlime.

3. The cockroach trap of claim 1, further comprising a cover disposed in a manner such that a gap is formed between the cover and the slant, wherein the gap functions as a path for cockroaches.

4. The cockroach trap of claims 1, wherein a material for attracting cockroaches is disposed on the first birdlime.

5. The cockroach trap of claims 4, wherein the material is selected from the group consisting of pheromone, feed, a dead body of a cockroach, and combinations thereof.

6. The cockroach trap of claim 3, wherein the gap is between 7 mm to 10 mm.

7. The cockroach trap of claim 1, wherein a portion of the plate is subsided and the first birdlime is adhered to the subsided portion of the plate.

8. The cockroach trap of claim 1, wherein the plate has more than one side and the inclined plane is formed at the end of the side along which the slant is disposed.

9. The cockroach trap of claim 8, wherein the slant angle of the inclined plane at the ends of the plate is smaller than the slope of the inclined plane of the slant.

10. The cockroach trap of claim 1, further comprising:
a sensor for detecting cockroaches passing the inclined plane of the slant, wherein the sensor is installed near both ends of the slant; and
a control unit connected to the sensor and being configured to count a number of the cockroaches detected by the sensor.

11. The cockroach trap of claim 10, wherein the sensor is selected from the group consisting of infrared sensor, ultrasonic sensor, laser sensor, electrostatic capacity sensor, and combinations thereof.

12. The cockroach trap of claim 11, further comprising a communication unit for transmitting the counted number of cockroaches to a remote place.

13. The cockroach trap of claim 1, further comprising a display for indicating a time to replace the birdlime.

14. The cockroach trap of claim 10, further comprising a display for indicating the status of the sensor or the control unit.

15. A cockroach trap, comprising:
a plate;
a first birdlime adhered to at least a portion of the plate;
a protruding part including at least one strip located on the plate and adjacent to at least a part of the first birdlime; and
a second birdlime adhered to side walls of the strip adjacent to the first birdlime.

16. The cockroach trap of claim 15, comprising at least one protruding part surrounding the first birdlime.

17. The cockroach trap of claim 15, further comprising a cover disposed in a manner such that a gap is formed between the cover and the protruding part, wherein the gap functions as a path for cockroaches.

18. The cockroach trap of claims 15, wherein a material for attracting cockroaches is disposed on the first birdlime.

19. The cockroach trap of claims 18, wherein the material is selected from the group consisting of pheromone, feed, a dead body of a cockroach, and combinations thereof.

20. The cockroach trap of claim 17, wherein the gap is between 7 mm to 10 mm.

21. The cockroach trap of claim 15, wherein a portion of the plate is subsided and the first birdlime is adhered to the subsided portion of the plate.

22. The cockroach trap of claim 15, wherein the plate has more than one side and an inclined plane is formed at the end of the side along which the protruding part is disposed.

23. The cockroach trap of claim 15, further comprising:
a sensor for detecting cockroaches passing the protruding part, wherein the sensor is installed near both ends of the protruding part; and
a control unit connected to the sensor and being configured to count a number of the cockroaches detected by the sensor.

24. The cockroach trap of claim 23, wherein the sensor is selected from the group consisting of infrared sensor, ultrasonic sensor, laser sensor, electrostatic capacity sensor, and combinations thereof.

25. A cock roach trap assembly including one or more cockroach traps, wherein at least one of the traps comprises:
a plate;
a first birdlime adhered to at least a portion of the plate;
a slant having an inclined plane and a vertical section, the slant being disposed on the plate and adjacent to at least a part of the first birdlime; and
a second birdlime adhered on the vertical section.
